(19) United States
(12) Patent Application Publication
(10) Pub. No.: US 2026/0362491 A1
(43) Pub. Date: Nov. 12, 2026

(54) METHOD AND APPARATUS FOR PERFORMING TIME DIVISION MULTIPLE ACCESS COMMUNICATION IN WLAN

(71) Applicant: HOLISTIC MANIFOLD INC., Daejeon (KR)

(72) Inventors: Yongho KIM, Incheon (KR); Juseong MOON, Osan-si (KR)

(73) Assignee: HOLISTIC MANIFOLD INC., Daejeon (KR)

(21) Appl. No.: 19/723,139

(22) Filed: Jun. 29, 2026

Related U.S. Application Data
(63) Continuation of application No. PCT/KR2024/021478, filed on Dec. 30, 2024.

(30) Foreign Application Priority Data
Dec. 29, 2023 (KR) 10-2023-0196152
Jan. 17, 2024 (KR) 10-2024-0007235

(51) Int. Cl. H04W 74/0816; H04W 28/02; H04W 72/0446; H04W 72/121; H04W 84/12

(52) U.S. Cl. CPC H04W 74/0816; H04W 28/0278; H04W 72/0446; H04W 72/121; H04W 84/12

(57) ABSTRACT

A method of operating a first access point (AP) coordinating time-division communication in a wireless LAN system, the method comprising: transmitting, by the first AP, a first frame; transmitting a second frame in a first communication period established by the first frame, wherein the first AP allocates, through the second frame, a second communication period to a second AP based on the time-division communication within the first communication period; and receiving a third frame from each of at least one AP including the second AP in response to the second frame, wherein the third frame is a frame that sets a second network allocation vector (NAV) in at least one wireless LAN terminal receiving the third frame, and communication by the second AP within the second communication period may be performed regardless of the NAV.

### CROSS REFERENCE TO RELATED APPLICATIONS

This application is a continuation application of International Application No. PCT/KR2024/021478, filed on Dec. 30, 2024, which claims priority to Korean Patent Application No. 10-2023-0196152, filed on Dec. 29, 2023, and Korean Patent Application No. 10-2024-0007235, filed on Jan. 17, 2024, the disclosures of which are incorporated herein by reference in their entities.

### FIELD

The present disclosure relates to a method and apparatus for performing time-division communication in a Wireless Local Area Network (WLAN). More specifically, the present disclosure relates to a method and apparatus for protecting a communication period in a case where communication is performed by time-dividing a communication period between users in a wireless LAN.

### DESCRIPTION OF THE RELATED ART

As the proliferation of mobile devices has recently expanded, wireless local area network (WLAN) technology capable of providing fast wireless communication services to mobile devices has been receiving significant attention. WLAN technology may be a technology that enables mobile devices, such as smartphones, smart pads, laptop computers, portable multimedia players, and embedded devices, to wirelessly access the Internet based on short-range wireless communication technology.

Standards utilizing WLAN technology are primarily being developed by the Institute of Electrical and Electronics Engineers (IEEE) as the IEEE 802.11 standard. As the aforementioned WLAN technology has been developed and disseminated, applications utilizing WLAN technology have diversified, and demand for WLAN technology supporting higher reliability has emerged.

As applications requiring higher reliability have emerged, the IEEE 802.11bn standard, which is an Ultra High Reliability (UHR) WLAN technology, is being developed for single Basic Service Set (BSS) environments and/or overlapping BSS environments. The goal of the IEEE 802.11bn standard may be to support improvements in data transmission rate, latency performance, and data error rate. In addition, the IEEE 802.11bn standard may support low-power operation, peer-to-peer communication, operations for increasing channel utilization, and coordinated time division multiple access (C-TDMA) operation among multiple APs.

However, when communication is performed using a coordinated time-division communication period, the time-divided communication period may not be protected. In an embodiment, the time-divided communication period may be intruded upon by other communication terminals. Accordingly, communication operations may not be performed during the time-divided communication period, and coordinated time-division communication operations may not be utilized.

Meanwhile, the technology serving as the background of the present disclosure has been described to promote understanding of the background of the present disclosure, and may include content that is not prior art already known to those of ordinary skill in the art to which this technology belongs.

### SUMMARY

The present disclosure relates to a method and apparatus for protecting a communication period when time-division communication is performed in a wireless LAN.

The present disclosure relates to a method and apparatus for preventing interference from occurring in a communication period by a wireless LAN terminal in a hidden node relationship when time-division communication is performed in a wireless LAN.

The present disclosure relates to a method and apparatus for at least one AP transmitting a CTS frame based on a multi-user request to send (MU-RTS) frame transmitted by an access point (AP) controlling time-division communication in a wireless LAN.

The present disclosure relates to a method and apparatus for an AP controlling time-division communication in a wireless LAN to distinguish a CTS frame received in response to transmission of an MU-RTS frame.

The technical objectives to be achieved in the present disclosure are not limited to the technical objectives mentioned above, and other technical objectives not mentioned will be clearly understood by those of ordinary skill in the art to which the present disclosure belongs from the description below.

In accordance with an embodiment of the present disclosure, a method of operating a first access point (AP) coordinating time-division communication in a wireless LAN system comprises: transmitting, by the first AP, a first clear to send (CTS) frame, wherein the first frame is a frame that sets a first network allocation vector (NAV) in at least one wireless LAN terminal receiving the first frame; transmitting a second frame in a first communication period set by the first frame, wherein the first AP allocates, through the second frame, a second communication period to a second AP based on time-division communication within the first communication period; and receiving a third frame from each of at least one AP including the second AP in response to the second frame, wherein the third frame is a frame that sets a second NAV in at least one wireless LAN terminal receiving the third frame, and communication by the second AP within the second communication period may be performed regardless of the NAV.

In accordance with an embodiment of the present disclosure, a first access point (AP) may comprise at least one transceiver, at least one processor configured to control the at least one transceiver, and a memory storing instructions that cause the wireless user device to perform specific operations by the at least one processor. Here, the specific operations comprise: transmitting, by the first AP, a first clear to send (CTS) frame, wherein the first frame is a frame that sets a first network allocation vector (NAV) in at least one wireless LAN terminal receiving the first frame; transmitting a second frame in a first communication period set by the first frame, wherein the first AP allocates, through the second frame, a second communication period to a second AP based on time-division communication within the first communication period; and receiving a third frame from each of at least one AP including the second AP in response to the second frame, wherein the third frame is a frame that sets a second NAV in at least one wireless LAN terminal receiving the third frame, and communication by the second AP within the second communication period may be performed regardless of the NAV.

In addition, the following may be commonly applied.

In accordance with an embodiment of the present disclosure, the second frame includes user information of the second AP to which the second communication period is allocated and user information of a third AP to which the second communication period is not allocated, and the second frame may further include at least one of an indicator indicating that the second AP is allocated the second communication period and an indicator indicating that the third AP is not allocated the second communication period.

In accordance with an embodiment of the present disclosure, the second frame includes a group identifier of at least one AP capable of being allocated the second communication period based on time-division communication, and the first AP may receive a third frame from each of at least one AP including the second AP based on the group identifier.

In accordance with an embodiment of the present disclosure, when a first parameter is included together with the group identifier in the second frame, the first AP may receive a third frame from each of at least one AP including the second AP.

In accordance with an embodiment of the present disclosure, the first NAV may be set to a time length indicated by a duration field of a medium access control (MAC) header included in the first frame, and the second NAV may be set to a time length indicated by a duration field of a MAC header included in the third frame.

In accordance with an embodiment of the present disclosure, a receiver address (RA) field in a third frame transmitted by a third AP to which the second communication period is not allocated based on the second frame is set to the first AP, and the second NAV set in at least one wireless LAN terminal through the third frame transmitted by the third AP may be set as a basic NAV.

In accordance with an embodiment of the present disclosure, the third frame that the first AP receives from each of at least one AP including the second AP is a simultaneous CTS (S-CTS) frame, and the first AP may simultaneously receive the third frame from each of the at least one AP including the second AP.

In accordance with an embodiment of the present disclosure, the first AP receives the third frame and detects communication of the second AP that has been allocated the second communication period for a preset period of time, and when communication of the second AP is not detected, the first AP may reallocate the second communication period.

In accordance with an embodiment of the present disclosure, the third frame transmitted by the second AP that has been allocated the second communication period and the third frame transmitted by a third AP that has not been allocated the second communication period are set to different bandwidths, and the first AP may identify the AP transmitting the third frame based on bandwidth information for each of the third frames simultaneously received.

In accordance with an embodiment of the present disclosure, the second frame further includes frequency information on which a CTS frame is transmitted, and a band on which the CTS frame is received may be set differently for each AP based on the frequency information on which the CTS frame is transmitted.

In accordance with an embodiment of the present disclosure, the first AP may receive the third frame from each of at least one AP including the second AP on different bands based on the frequency information on which the CTS frame is transmitted.

In accordance with an embodiment of the present disclosure, the first AP may receive, through the entire band based on the second frame, the third frame simultaneously transmitted from each of at least one AP including the second AP, and may then receive a fourth frame from each of at least one AP including the second AP on different bands based on the frequency information on which the CTS frame is transmitted.

In accordance with an embodiment of the present disclosure, the first AP may transmit, after transmitting the first frame, an NDP (null data PPDU) Feedback Report Poll (NFRP) trigger frame to at least one AP including the second AP, and may transmit the second frame after receiving an NDP feedback frame from each of the at least one AP including the second AP.

In accordance with an embodiment of the present disclosure, the NFRP trigger frame includes identification information identifying each of at least one AP including the second AP, and the NDP feedback frame transmitted from each of the at least one AP including the second AP may be received on a band corresponding to the identification information.

In accordance with an embodiment of the present disclosure, the first AP may transmit, after transmitting the first frame, a Buffer Status Report Poll (BSRP) trigger frame to at least one AP including the second AP, and may transmit the second frame after receiving a buffer status report from each of the at least one AP including the second AP.

In accordance with an embodiment of the present disclosure, the BSRP trigger frame indicates a band on which the buffer status report is transmitted, and the buffer status report transmitted from each of the at least one AP including the second AP may be received on the band indicated by the BSRP trigger frame.

According to the present disclosure, a method of protecting a communication period when time-division communication is performed in a wireless LAN may be provided.

According to the present disclosure, a method of preventing interference from occurring in a communication period by a wireless LAN terminal in a hidden node relationship when time-division communication is performed in a wireless LAN may be provided.

According to the present disclosure, a method in which at least one AP transmits a CTS frame based on an MU-RTS frame transmitted by an AP controlling time-division communication in a wireless LAN may be provided.

According to the present disclosure, a method in which an AP controlling time-division communication in a wireless LAN distinguishes a CTS frame received in response to transmission of an MU-RTS frame may be provided.

The effects obtainable from the present disclosure are not limited to the effects mentioned above, and other effects not mentioned will be clearly understood by those of ordinary skill in the art to which the present disclosure belongs from the description below.

### BRIEF DESCRIPTION OF THE DRAWINGS

FIG. 1 is a diagram illustrating a communication node in a wireless LAN system to which the present disclosure is applied.

FIG. 2 is a diagram illustrating a wireless LAN system to which the present disclosure is applied.

FIG. 3 is a diagram illustrating a machine learning unit to which the present disclosure is applied.

FIG. 4 is a flowchart illustrating a method of performing communication based on a machine learning unit to which the present disclosure is applied.

FIG. 5 is a diagram illustrating a problem that may occur when a coordinated time-division communication operation is performed in a wireless LAN to which the present disclosure is applied.

FIG. 6 is a diagram illustrating a method of protecting a communication period when a coordinated time-division communication operation is performed in a wireless LAN to which the present disclosure is applied.

FIG. 7 is a diagram illustrating a method of protecting a communication period when a coordinated time-division communication operation is performed in a wireless LAN to which the present disclosure is applied.

FIG. 8a and FIG. 8b are diagrams illustrating a method of protecting a communication period when a coordinated time-division communication operation is performed in a wireless LAN to which the present disclosure is applied.

FIG. 9a and FIG. 9b are diagrams illustrating a method of protecting a communication period when a coordinated time-division communication operation is performed in a wireless LAN to which the present disclosure is applied.

FIG. 10 is a flowchart illustrating a method of protecting a communication period when a coordinated time-division communication operation is performed in a wireless LAN to which the present disclosure is applied.

### DETAILED DESCRIPTION

The present disclosure is susceptible to various modifications and may have various embodiments, and specific embodiments will be illustrated in the drawings and described in detail. However, this is not intended to limit the present disclosure to specific embodiments, and it should be understood that the present disclosure includes all modifications, equivalents, and substitutes within the spirit and technical scope of the present disclosure.

Terms such as first, second, etc. may be used to describe various components, but the components should not be limited by the terms. The terms are used only for the purpose of distinguishing one component from another component. In an embodiment, a first component may be designated as a second component, and similarly, a second component may also be designated as a first component, without departing from the scope of the present disclosure. The term “and/or” includes any combination of a plurality of related listed items or any one of a plurality of related listed items.

When a component is referred to as being “connected” or “coupled” to another component, it should be understood that the component may be directly connected or coupled to the other component, but another component may also exist in between. On the other hand, when a component is referred to as being “directly connected” or “directly coupled” to another component, it should be understood that no other component exists in between.

The terms used in the present disclosure are used only to describe specific embodiments and are not intended to limit the present disclosure. Singular expressions include plural expressions unless the context clearly indicates otherwise. In the present disclosure, terms such as “comprise” or “have” are intended to designate the presence of features, numbers, steps, operations, components, parts, or combinations thereof described in the specification, and should be understood as not precluding the possibility of the presence or addition of one or more other features, numbers, steps, operations, components, parts, or combinations thereof.

Unless otherwise defined, all terms used herein, including technical or scientific terms, have the same meaning as commonly understood by those of ordinary skill in the art to which the present disclosure pertains. Terms defined in commonly used dictionaries should be interpreted as having meanings consistent with the meanings they have in the context of the relevant art, and unless explicitly defined in the present disclosure, should not be interpreted in an ideal or excessively formal sense.

Hereinafter, preferred embodiments of the present disclosure will be described in greater detail with reference to the accompanying drawings. In describing the present disclosure, the same reference numerals are used for the same components in the drawings to facilitate overall understanding, and duplicate descriptions of the same components are omitted.

In the following, a wireless communication system to which embodiments according to the present disclosure are applied will be described. The wireless communication system to which the embodiments according to the present disclosure are applied is not limited to the content described below, and the embodiments according to the present disclosure may be applied to various wireless communication systems. A wireless communication system may be referred to as a “wireless communication network.”

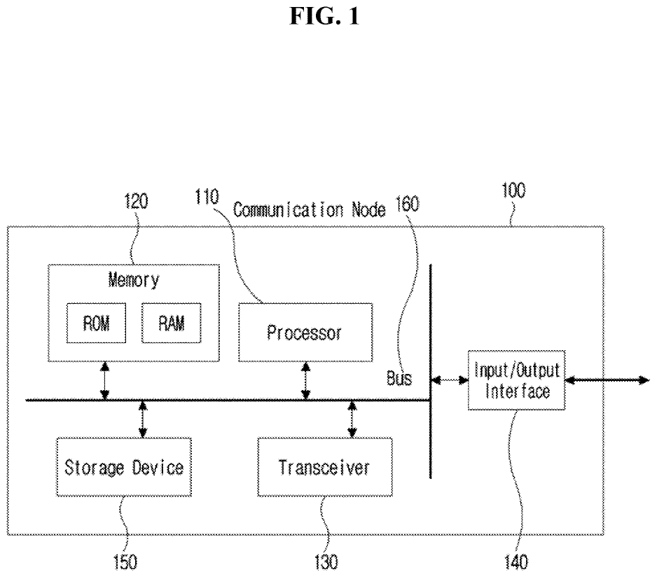

FIG. 1 is a diagram illustrating a communication node in a wireless LAN system to which the present disclosure is applied. Referring to FIG. 1, a communication node (100) may include at least one of a processor (110), a memory (120), a transceiver (130), an input/output interface (140), a storage device (150), and a bus (160). In an embodiment, the communication node (100) may be an access point (AP), a station (STA), an AP multi-link device (MLD), or a non-AP MLD. However, the communication node may not be limited thereto, and may be a node that communicates with other nodes or devices based on the configuration. In an embodiment, an operating channel width supported by an AP may be 20 MHz (megahertz), 80 MHz, 160 MHz, or the like. An operating channel width supported by a station may be 20 MHz, 80 MHz, or the like. However, the present disclosure may not be limited thereto.

The processor (110) within the communication node (100) may control at least one of the memory (120), the transceiver (130), the input/output interface (140), and the storage device (150) as respective components within the communication node. The memory (120) within the communication node (100) may store information regarding instructions and directives executed by the processor (110), and the transceiver (130) may refer to a transceiver, a radio frequency (RF) unit, an RF module, or any other component that performs signal transmission and reception. The input/output interface (140) within the communication node (100) is an interface for input and output that may interoperate with other interfaces, and may further include a separate storage device (150). Each of the components within the communication node (100) may be connected via a bus (160) to communicate with one another.

However, as an embodiment, each of the components included in the communication node (100) may be connected not via a common bus (160), but via individual interfaces or individual buses centered around the processor (110). The processor (110) may be connected to at least one of the memory (120), the transceiver (130), the input/output interface (140), and the storage device (150) via a dedicated interface.

The processor (110) may execute program commands stored in at least one of the memory (120) or the storage device (150). The processor (110) may refer to a central processing unit (CPU), a graphics processing unit (GPU), or a dedicated processor on which methods according to embodiments of the present disclosure are performed. Each of the memory (120) and the storage device (150) may be configured as at least one of a volatile storage medium or a non-volatile storage medium. In an embodiment, the memory (120) may be configured as at least one of a read only memory (ROM) or a random access memory (RAM).

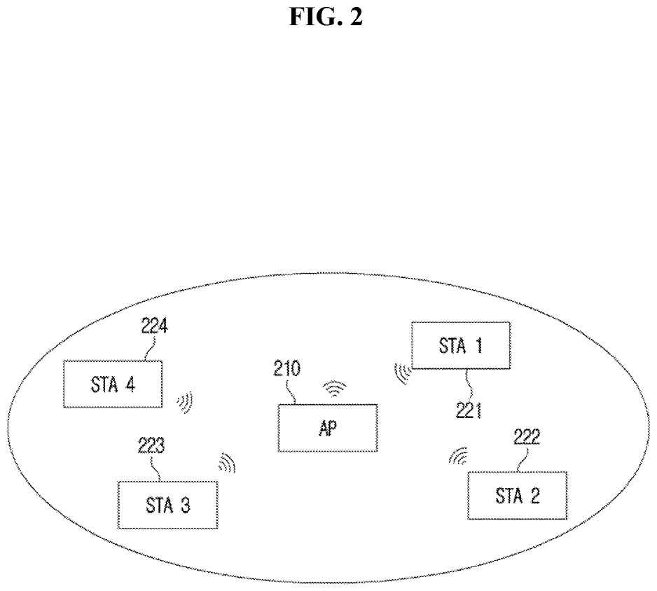

FIG. 2 is a diagram illustrating a wireless LAN system to which the present disclosure is applied. Referring to FIG. 2, a basic service set (BSS) of the wireless LAN system may include one AP (210) and a plurality of STAs (221, 222, 223, 224), and the plurality of STAs (221, 222, 223, 224) may be controlled by the AP (210). However, the wireless LAN system is not limited to a BSS, and an environment consisting only of STAs without a defined service set or AP may also be considered, and the wireless LAN system is not limited to any specific form. Each of the wireless devices within the wireless LAN system may include a medium access control (MAC) layer and a physical (PHY) layer, and communication between the wireless devices may be performed. In the following description, the AP and STA are primarily described for convenience of explanation, but the description may not be limited thereto. In an embodiment, the following may be equally applicable to other communication nodes or devices, and is not limited to any specific form.

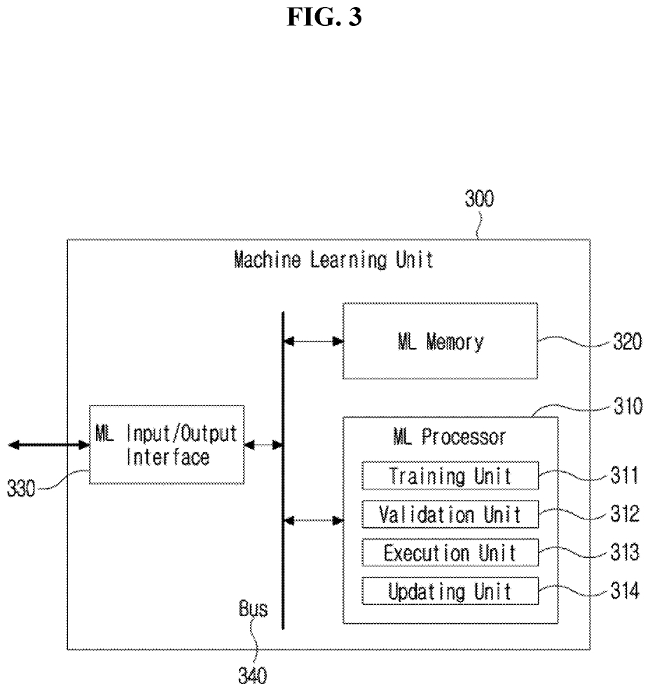

FIG. 3 is a diagram illustrating a machine learning unit to which the present disclosure is applied. Each of the wireless devices within the wireless LAN system may be connected to a machine learning unit (300). However, the present disclosure may not be limited thereto, and it may also be possible for a wireless device that is not connected to the machine learning unit (300) to operate.

In an embodiment, the processor (110) of the communication node (100) of FIG. 1 may be connected to the machine learning unit (300). The machine learning unit (300) may communicate with the processor (110) via the input/output interface (140) of the communication node (100). As another embodiment, the machine learning unit (300) may communicate with the processor (110) via the bus (160) of the communication node (100). As yet another embodiment, the machine learning unit (300) may be connected to and communicate with the processor (110) of the communication node (100) via an individual interface or a dedicated bus. The machine learning unit (300) may be connected to and communicate with the memory (120), the transceiver (130), and the storage device (140) via the input/output interface (140), the bus (160), or a dedicated bus of the communication node (100), but may not be limited to any specific form.

In an embodiment, the machine learning unit (300) may include at least one machine learning (ML) processor (310), an ML memory (320), an ML input/output interface (330), and ML buses (340). The ML processor (310), the ML memory (320), and the ML input/output interface (330) may be connected to and communicate with one another via the ML bus (340). As another embodiment, the ML processor (310) may be connected to and communicate with at least one of the ML memory (320) and the ML input/output interface (330) via a dedicated bus or interface. The ML processor (310) may be a central processing unit, a graphics processing unit, a dedicated processor on which methods according to embodiments of the present disclosure are performed, or a processor combining at least one of a central processing unit and a dedicated processor. The ML processor (310) may include at least one of a training unit (311), a validation unit (312), an execution unit (313), and an updating unit (314). The training unit (311), the validation unit (312), the execution unit (313), and the updating unit (314) may be logical entities implemented in software or hardware processing devices. In an embodiment, the ML processor (310) may perform at least one of training, validation, execution, and updating of a machine learning model. The machine learning model may be in the form of a plurality of matrices or vectors. As a specific embodiment, the machine learning model may include weights, transition matrices, and hyperparameters that implement and train single or multiple combined machine learning algorithms (e.g., deep neural network (DNN), convolutional neural network (CNN), recurrent neural network (RNN), and deep reinforcement learning (DRL) algorithms). The machine learning model may include an input layer, at least one hidden layer, and an output layer to implement a DNN algorithm. Each of the input layer, the hidden layer, and the output layer may include at least one perceptron (e.g., an artificial neuron). A perceptron includes an activation function, input weights, and a bias. A plurality of perceptron may have their inputs and outputs connected to form the input layer, the hidden layer, and the output layer. The machine learning model may include a convolution algorithm and the DNN algorithm to implement a CNN algorithm. The convolution algorithm is an algorithm that applies a kernel matrix to input data in matrix form via convolution, and may be performed at least once on the input data. When the convolution algorithm is performed on the input data, the size of the data may increase through concatenation or decrease through pooling. Input data on which the convolution algorithm has been performed at least once is used as input data for the DNN algorithm. In an embodiment, the machine learning model may include a DNN algorithm and a cell structure to implement an RNN algorithm. The cell structure may be a structure that memorizes previous input data and feeds it back as input, and may be used in at least one perceptron of the DNN algorithm. The machine learning model may include an agent, an environment structure, and a DNN algorithm to implement a DRL algorithm. In the DRL algorithm, the agent may observe the environment and perform an optimal action based thereon. The environment may provide feedback to the agent in the form of a reward based on the action of the agent. Based on the foregoing, the agent may learn a policy for taking optimal actions. The agent may use a DNN algorithm to learn optimal actions.

As another embodiment, the machine learning unit (300) may be designed to additionally implement other machine learning algorithms beyond those already implemented. To this end, the machine learning unit (300) may include additional components for implementing other machine learning algorithms. The ML memory (320) within the machine learning unit (300) may store machine learning models and machine learning algorithms. Implementation of a machine learning algorithm may be performed by the ML processor (310) based on the machine learning model.

As another embodiment, all or part of the functions of the machine learning unit (300) may be integrated into the processor (110) and the memory (120) of the communication node (100). That is, the processor (110) of the communication node (100) may perform some or all of the functions of the ML processor (310), and the memory (120) may perform all or some of the functions of the ML memory (320). When the processor (110) and the memory (120) of the communication node (100) perform all functions of the machine learning unit (300), the machine learning unit (300) may not be connected via the input/output interface (140), and the processor (110) and the memory (120) may operate as the machine learning unit (300).

As another embodiment, the machine learning unit (300) may not be connected via the input/output interface (140) of the communication node (100), but may be connected via the bus (160), or via a dedicated bus or interface centered around the processor (110) of the communication node (100), but the present disclosure may not be limited to such embodiments.

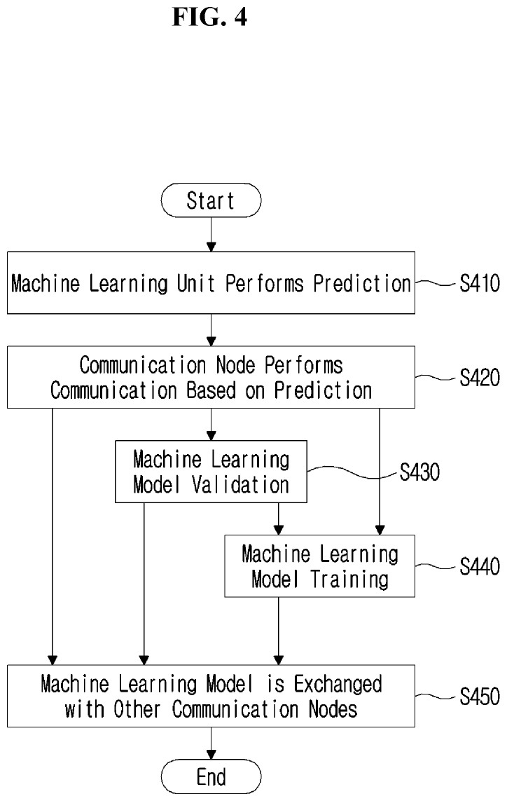

FIG. 4 is a flowchart illustrating a method of performing communication based on a machine learning unit to which the present disclosure is applied. Referring to FIG. 4, the machine learning unit (300) may be connected to the communication node (100) to collect communication data and perform prediction based on a machine learning model (S410). In an embodiment, the prediction may be performed by the execution unit (313) of the machine learning unit (300), but is not limited thereto. Here, the communication data collected by the machine learning unit (300) may include at least one of channel noise status, channel congestion, received signal strength, collision frequency, and other information obtained from the physical layer. In addition, the communication data may include information obtained from the MAC layer, and is not limited to any specific form. The communication data collected by the machine learning unit (300) may be provided as input to the machine learning model as-is. As another embodiment, the communication data collected by the machine learning unit (300) may be processed or pre-processed before being provided as input to the machine learning model. In an embodiment, the prediction result of the machine learning unit (300) may be at least one of physical layer and MAC parameters (e.g., modulation and coding scheme (MCS) parameters, beamforming parameters, enhanced distributed channel access (EDCA) parameters, etc.). As another embodiment, the prediction result of the machine learning unit (300) may be information for packet scheduling, multi-AP operation scheduling, and other scheduling, but is not limited to any specific form. As another embodiment, the communication node (100) may receive all or part of a machine learning model from another communication node. All or part of the machine learning model may be collected by the machine learning unit (300), and is not limited to any specific form. In an embodiment, the communication node (100) may perform communication based on the prediction of the machine learning unit (300) (S420). In addition, the machine learning unit (300) may collect communication data based on the performed communication, and based thereon, machine learning model validation (S430) or machine learning model training (S440) may be performed. Also, In an embodiment, the machine learning model may be exchanged with other communication nodes (S450), and the exchanged machine learning model information may be used for machine learning model validation or machine learning model training. In an embodiment, when machine learning model validation is performed, it may be verified whether the communication operation performed by the prediction of the machine learning unit (300) is appropriate. As a specific embodiment, machine learning model validation may be performed based on at least one of the frame collision frequency, transmission error frequency, and packet transmission delay of the communication node (100), and an operation of determining whether the communication performance of the communication node (100) has improved may be performed.

In addition, In an embodiment, when it is determined that training of the machine learning model is necessary (e.g., when communication performance has not improved, or when the performance of the machine learning model of another communication node (e.g., all or part of the machine learning model) is determined to be superior to the machine learning model of the current communication node (100)), the communication node (100) may perform machine learning model training. As another embodiment, the communication node (100) may exchange the machine learning model with other communication nodes without performing machine learning model validation or machine learning model training. Also, In an embodiment, when it is determined that training of the machine learning model is not necessary, the communication node (100) may exchange the machine learning model with other communication nodes without performing machine learning model training.

Here, the training of the machine learning model may be performed based on at least one of the collected communication data and all or part of the machine learning model of another communication node. The training of the machine learning model may be performed by the training unit (311), and may be performed based on at least one of the collected communication data, the machine learning model of another communication node, and the output of the machine learning model of the communication node (100).

As another embodiment, all or part of the machine learning model of the communication node (100) may be replaced with all or part of the machine learning model of another communication node by the updating unit (314) of the machine learning unit (300). As another embodiment, the machine learning model (e.g., all or part of the machine learning model) of the communication node (100) may be shared with other communication nodes. Alternatively, it may also be possible for the communication node (100) to operate based solely on machine learning model validation and training without exchanging the machine learning model with other communication nodes, and the present disclosure is not limited to any specific form. In an embodiment, in the flowchart of the present disclosure, at least one of reordering of steps, addition or removal of steps, and repetition of specific steps may be performed. That is, the present flowchart is one embodiment illustrating the operation of the machine learning unit (300) of the wireless communication node (100), and the procedures and operations may be variously modified. In an embodiment, it may also be possible for the machine learning model validation step to be performed again after machine learning model training in order to validate the trained machine learning model, and the present disclosure may not be limited to any specific form. Hereinafter, operations related to wireless LAN terminals are described with reference to a station (STA). As used in accordance with IEEE 802.11 terminology, “STA” may refer to both an AP STA operating as an access point (AP) and a non-AP STA operating in connection with an AP. However, for convenience of description, an AP and a non-AP STA are distinguished herein; this distinction is made solely for descriptive purposes, and it will be apparent that operations described with respect to the AP may apply to both AP STAs and non-AP STAs. Likewise, it will be apparent that operations described with respect to a non-AP STA may also apply to both non-AP STAs and AP STAs. Each wireless device within a wireless LAN system may include a medium access control (MAC) layer and a physical (PHY) layer, and communication between wireless devices may be performed. Although the following description focuses on APs and non-AP STAs for convenience of explanation, the present disclosure is not limited thereto. For example, the following may apply equally to other communication nodes or devices and is not limited to any specific form. In addition, an operation considering data that requires a reduction in channel access delay is described below. Here, the data requiring a reduced channel access delay may be referred to as low-latency data, low-latency traffic, or other terms, and may not be limited to a specific form. As an embodiment, indication operations or other operations performed below may be interpreted as indication operations or other operations for low latency. For convenience of explanation, the following description uses the terms “data” or “traffic,” but as described above, these may be data requiring a reduction in channel access delay, low-latency data, or low-latency traffic, and are not limited to a specific form.

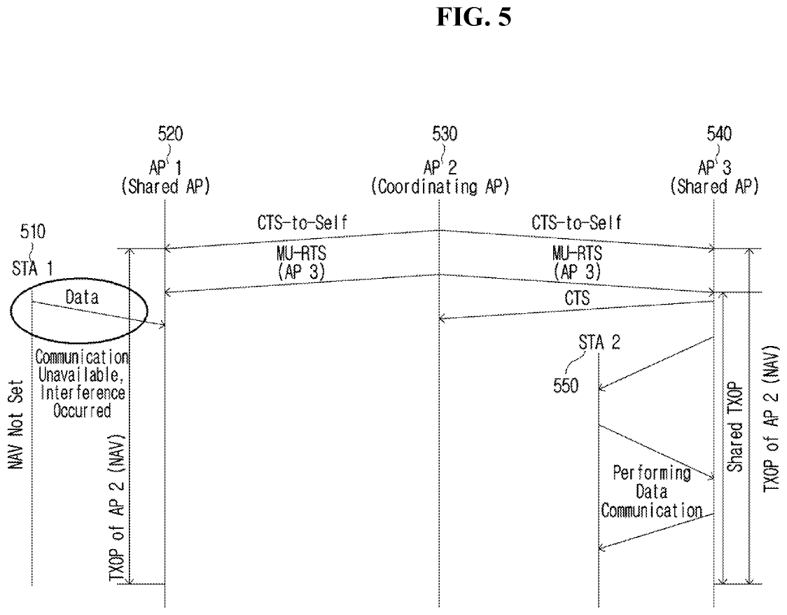

FIG. 5 is a diagram illustrating a problem that may occur when a coordinated time-division communication operation is performed in a wireless LAN to which the present disclosure is applied.

Referring to FIG. 5, a plurality of access points (APs) may operate in a wireless LAN. In an embodiment, AP 1 through AP 3 (520, 530, 540) may operate in the wireless LAN. Here, AP 2 (530) may be a coordinating AP that coordinates a coordinated time division multiple access (C-TDMA) method. AP 2 (530) may establish a transmission opportunity (TXOP) on the channel in order to use C-TDMA. Here, the TXOP is a time interval during which a plurality of frames may be transmitted. The TXOP may be established via a CTS frame (In an embodiment, a CTS-to-Self frame wherein the receiver address is set to the MAC address of AP 2). In an embodiment, the TXOP may also be established via transmission of a multi-user request to send (MU-RTS) frame or a data frame. The following description is based on the case where the TXOP is established using a CTS-to-Self frame, but may not be limited thereto.

Referring to FIG. 5, AP 1 (520) and AP 3 (540) may receive the CTS-to-Self frame (or CTS frame) transmitted by AP 2 (530), and may set a network allocation vector (NAV) based on the time length indicated by the duration field included in the medium access control (MAC) header of the CTS-to-Self frame. The NAV may be set to correspond to the length of the TXOP established by AP 2 (530). Here, STA 1 (510) connected to AP 1 (520) may be in a hidden node relationship with AP 2 (530), and STA 1 (510) may not be able to receive the CTS-to-Self frame transmitted by AP 2 (530). Accordingly, STA 1 (510) may not be able to set the NAV.

In an embodiment, when the NAV is set in a wireless LAN terminal, wireless LAN terminals including APs and non-AP STAs (i.e., STAs) may detect the channel as busy based on virtual carrier sensing and may not be able to perform frame transmission. That is, when the NAV is set in a wireless LAN terminal, the wireless LAN terminal may wait without performing frame transmission. In FIG. 5, the NAV may be set in AP 1 (520) and AP 3 (540) by the CTS-to-Self frame, thereby ensuring the TXOP of AP 2 (530). AP 2 (530) may transmit an MU-RTS frame to allocate a C-TDMA communication period within the TXOP. The MU-RTS frame may include a user information field containing information on AP 3 (540) (In an embodiment, the association identifier (AID) of AP 3) to which the C-TDMA communication period is to be allocated. AP 3 (540) may receive an allocation of the C-TDMA communication period and may transmit a CTS frame in response to the MU-RTS frame. In an embodiment, the CTS frame transmitted in response to the MU-RTS frame may be a simultaneous CTS frame. That is, the CTS frame may be a CTS frame that a plurality of STAs may simultaneously transmit, but may not be limited thereto. Since the CTS frame is an immediate response frame to the MU-RTS frame, it may be transmitted as a response even when the NAV is set. AP 3 (540) may perform communication with other wireless LAN terminals during the allocated C-TDMA communication period (or shared TXOP). That is, AP 3 (540) may communicate with a STA connected to AP 3 (540) (In an embodiment, STA 2 (550)) while ignoring the NAV set during the C-TDMA communication period.

Here, STA 1 (510) may not be able to receive the MU-RTS frame of AP 2 (530). In an embodiment, STA 1 (510) may be a hidden node from the perspective of AP 2 (530). When STA 1 (510) and AP 2 (530) are in a hidden node relationship, STA 1 (510) may not detect transmissions from AP 2 (530), and AP 2 (530) may not detect transmissions from STA 1 (510). In an embodiment, STA 1 (510) may have received the MU-RTS frame of AP 2 (530) but may not be able to receive the response frame (CTS frame) from AP 3 (540). In the aforementioned cases, STA 1 (510) may not set the NAV, and STA 1 (510) may transmit a data frame to AP 1 (520). In an embodiment, AP 1 (520) may set the NAV based on frames transmitted from AP 2 (530). Here, when the data frame transmitted by STA 1 (510) requests an immediate response, AP 1 (520) may transmit an immediate response frame regardless of the NAV. However, in the aforementioned situation, the immediate response frame transmitted by AP 1 (520) may act as interference to AP 3 (540). Accordingly, there is a need to prevent AP 1 (520) from transmitting the immediate response frame, and if AP 1 (520) does not transmit the immediate response frame to STA 1 (510), interference may not occur. However, in the aforementioned situation, the backoff contention window of STA 1 (510) (Enhanced Distributed Channel Access (EDCA) backoff contention window) may increase, and the communication efficiency of STA 1 (510) may decrease. In addition, when there is no separate method to prevent AP 1 (520) from transmitting the immediate response frame, the immediate response frame transmitted by AP 1 (520) may act as interference to AP 3 (540). Accordingly, the communication efficiency of not only AP 1 (520) and STA 1 (510), but also AP 3 (540) and STA 2 (550) may decrease.

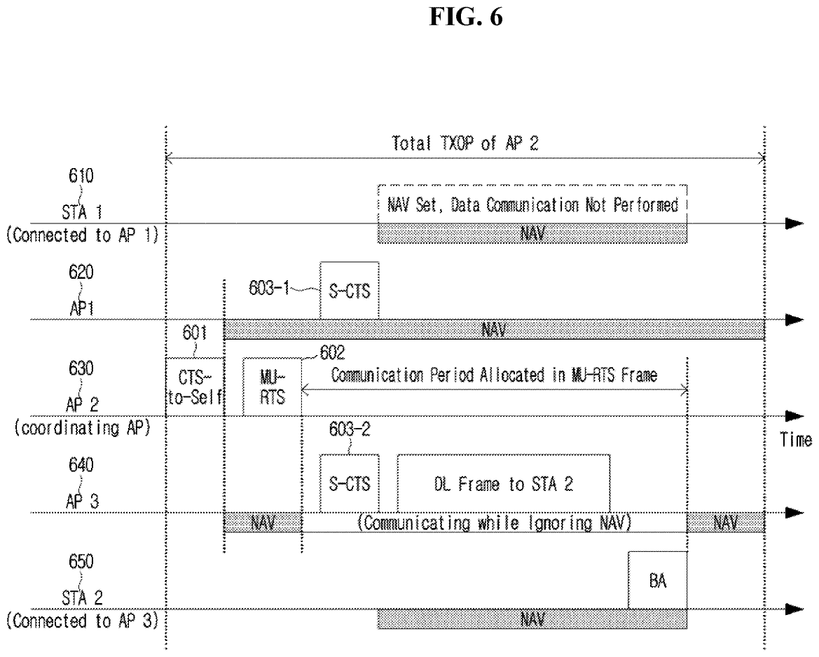

FIG. 6 is a diagram illustrating a method of protecting a communication period when a coordinated time-division communication operation is performed in a wireless LAN to which the present disclosure is applied.

Referring to FIG. 6, a plurality of access points (APs) may operate in a wireless LAN. In an embodiment, AP 1 through AP 3 (620, 630, 640) may operate in the wireless LAN. Here, AP 2 (630) may be a coordinating AP that coordinates a coordinated time division multiple access (C-TDMA) method. AP 2 (630) may establish a transmission opportunity (TXOP) on the channel in order to use C-TDMA. Here, the TXOP is a time interval during which a plurality of frames may be transmitted. The TXOP may be established via a CTS frame (In an embodiment, a CTS-to-Self frame wherein the receiver address is set to the MAC address of AP 2). In an embodiment, the TXOP may also be established via transmission of a multi-user request to send (MU-RTS) frame or a data frame. The following description is based on the case where the TXOP is established using a CTS-to-Self frame, but may not be limited thereto.

Referring to FIG. 6, AP 1 (620) and AP 3 (640) may receive the CTS-to-Self frame (or CTS frame, 601) transmitted by AP 2 (630), and may set a network allocation vector (NAV) based on the time length indicated by the duration field included in the medium access control (MAC) header of the CTS-to-Self frame (601). The NAV may be set to correspond to the length of the TXOP established by AP 2 (630). Here, STA 1 (610) connected to AP 1 (620) may be in a hidden node relationship with AP 2 (630), and STA 1 (610) may not be able to receive the CTS-to-Self frame (601) transmitted by AP 2 (630). Accordingly, STA 1 (610) may not be able to set the NAV.

In an embodiment, when the NAV is set in a wireless LAN terminal, wireless LAN terminals including APs and non-AP STAs (i.e., STAs) may detect the channel as busy based on virtual carrier sensing and may not be able to perform frame transmission. That is, when the NAV is set in a wireless LAN terminal, the wireless LAN terminal may wait without performing frame transmission. In FIG. 6, the NAV may be set in AP 1 (620) and AP 3 (640) by the CTS-to-Self frame (601), thereby ensuring the TXOP of AP 2 (630). AP 2 (630) may transmit an MU-RTS frame (602) to allocate a C-TDMA communication period within the TXOP. The MU-RTS frame (602) may include a user information field containing information on AP 3 (640) (In an embodiment, the association identifier (AID) of AP 3) to which the C-TDMA communication period is to be allocated. AP 3 (640) may receive an allocation of the C-TDMA communication period and may transmit a CTS frame in response to the MU-RTS frame (602). In an embodiment, the CTS frame transmitted in response to the MU-RTS frame (602) may be a simultaneous CTS frame. That is, the CTS frame may be a CTS frame that a plurality of wireless LAN terminals may simultaneously transmit, but may not be limited thereto.

In addition, AP 1 (620) may also transmit a CTS frame (603-1) in response to the MU-RTS frame (602) of AP 2 (630). Here, AP 1 (620) may be an AP that is capable of performing C-TDMA communication but has not been allocated a communication period. More specifically, the MU-RTS frame (602) transmitted by AP 2 (630) may also include information on AP 1 (620) that is capable of performing C-TDMA communication but has not been allocated a communication period (In an embodiment, a user information field containing the AID of AP 1). The information within the MU-RTS frame (602) transmitted by AP 2 (630) may include information on at least one of an indicator indicating that AP 3 (640) is allocated the C-TDMA communication period and an indicator indicating that AP 1 (620) is not allocated the C-TDMA communication period.

In an embodiment, when the MU-RTS frame (602) transmitted by AP 2 (630) allocates a C-TDMA communication period, AP 1 (620) may transmit a CTS frame (603-1) as a response. Here, the MU-RTS frame (602) may include an indicator indicating that a C-TDMA communication period is being allocated.

In an embodiment, the MU-RTS frame (602) transmitted by AP 2 (630) may include a group identifier of APs that may be subject to C-TDMA operation. The group identifier of the APs may also be referred to as a Multiple-AP (MAP) ID, but may not be limited to such a designation. In an embodiment, the MAP ID may be designated and used as one of the unused (or reserved) AIDs. Alternatively, the MAP ID may be designated through pre-negotiation among APs. Alternatively, the MAP ID may be used as a pre-determined value, and is not limited to any specific form. Here, AP 1 (620) may be aware of the MAP ID of the group to which AP 1 (620) belongs. Accordingly, when the AID corresponding to the MAP ID is included in the user information of the MU-RTS frame (602), AP 1 (620) may transmit a simultaneous CTS frame (603-1) as an immediate response. In addition, AP 3 (640) may also be aware of the MAP ID of the group to which AP 3 (640) belongs. Accordingly, when the AID corresponding to the MAP ID is included in the user information of the MU-RTS frame (602), AP 3 (640) may transmit a simultaneous CTS frame (603-2) as an immediate response.

In an embodiment, AP 1 (620) may transmit a simultaneous CTS frame (603-1) based on whether the MU-RTS frame (602) transmitted by AP 2 (630) includes a “SCRAMBLER_INITIAL_VALUE.” The “SCRAMBLER_INITIAL_VALUE” of the transmission vector (TXVECTOR) parameter present in the PHY preamble of the simultaneous CTS frame (603-1) must be set identically to the “SCRAMBLER_INITIAL_VALUE” of the reception vector (RXVECTOR) parameter present in the MU-RTS frame (602) for transmission. Accordingly, AP 1 (620) may perform transmission configuration using the “SCRAMBLER_INITIAL_VALUE” included in the MU-RTS frame (602) and then transmit the simultaneous CTS frame (603-1).

In an embodiment, the aforementioned operations may be used in combination and may not be limited to any single method. As a specific embodiment, even when the “SCRAMBLER_INITIAL_VALUE” is included in the MU-RTS frame (602), if the MAP ID does not correspond to the AID of the group to which the AP belongs, the simultaneous CTS frame (603-1) may not be transmitted. In an embodiment, even when the MAP ID corresponds to the AID of the group to which the AP belongs, if the “SCRAMBLER_INITIAL_VALUE” is not included, AP 1 (620) may not transmit the simultaneous CTS frame (603-1). In an embodiment, if the MU-RTS frame (602) includes allocation information for AP 1 (620), AP 1 (620) may be required to transmit the simultaneous CTS frame (603-1) without any other conditions.

In an embodiment, AP 3 (640) may communicate with a STA connected to AP 3 (640) (In an embodiment, STA 2 (650)) while ignoring the NAV set during the C-TDMA communication period, based on the allocated C-TDMA communication period (or shared TXOP). AP 3 (640) may transmit a downlink frame to STA 2 (650) or trigger uplink frame transmission. AP 3 (640) may transmit a trigger frame to STA 2 (650) to trigger uplink frame transmission by STA 2 (650). In an embodiment, the trigger frame transmitted to STA 2 (650) may have the CS required field set to 0. Accordingly, when STA 2 (650) receives the trigger frame, STA 2 (650) may transmit an uplink frame (In an embodiment, an uplink (UL) trigger-based (TB) physical layer protocol data unit (PPDU)) to AP 3 (640) regardless of whether the channel state detected by the NAV (i.e., virtual carrier sensing) or physical carrier sensing is in an idle state or a busy state. Here, since AP 3 (640) has been allocated a communication period from AP 2 (630), AP 3 (640) may transmit a trigger frame with the CS required bit set to 0 to STA 2 (650).

In an embodiment, STA 1 (610) may not be able to receive the MU-RTS frame (602) of AP 2 (630), but may be able to receive the CTS frame (603-1) of AP 1 (620). That is, as described above, AP 1 (620), which has not been allocated a C-TDMA communication period (or shared TXOP) from AP 2 (630), may transmit a CTS frame (603-1), and STA 1 (610) may receive the CTS frame (603-1) transmitted by AP 1 (620). Accordingly, STA 1 (610) may set the NAV for the time length indicated by the duration field included in the MAC header of the CTS frame (603-1) of AP 1 (620). That is, STA 1 (610) may not transmit a data frame to AP 1 (620) for the time length indicated by the duration field, thereby preventing interference with C-TDMA communication caused by frame transmission from STA 1 (610).

In an embodiment, since the CTS frame (603-1) transmitted by AP 1 (620) is transmitted to AP 2 (630), the receiver address (RA) field may be set to AP 2 (630). The RA field of the CTS frame (603-1) received by STA 1 (610) from AP 1 (620) may be AP 2 (630), and accordingly, a basic NAV may be set in STA 1 (610). That is, STA 1 (610) may set the basic NAV even though the CTS frame (603-1) is a frame transmitted by AP 1 (620) within the same BSS.

In an embodiment, the basic NAV may be set when the PPDU received by a wireless LAN terminal does not correspond to either an intra-BSS PPDU or an inter-BSS PPDU. Here, when a wireless LAN terminal receives a CTS frame, which is a control frame that includes only an RA field without a transmitter address (TA) field, the wireless LAN terminal may determine that the frame does not correspond to either an intra-BSS or inter-BSS frame if the RA field does not match the address of the previous TXOP holder, or does not match the address of the currently associated BSS or another BSS within the same Multiple BSSID Set/Co-Hosted BSSID Set.

More specifically, when a wireless LAN terminal receives a PPDU, the wireless LAN terminal may determine whether the PPDU is an intra-BSS PPDU or an inter-BSS PPDU. As a specific embodiment, a wireless LAN terminal may determine a received PPDU as an intra-BSS PPDU when the “BSS_COLOR” value of the reception vector (RXVECTOR) parameter of the received PPDU is 0 or is identical to the “BSS_COLOR” value of the currently associated BSS. In addition, with respect to a very high throughput (VHT) PPDU, a wireless LAN terminal may determine a received PPDU as an intra-BSS PPDU when the partial AID (PARTIAL_AID) value of the reception vector (RXVECTOR) of the received PPDU is identical to the BSSID of the currently associated BSS or the BSSID of another BSS within the same Multiple BSSID Set or Co-Hosted BSSID Set, and the GROUP_ID is 0. In addition, with respect to a CTS frame, which is a control frame containing only an RA field, a wireless LAN terminal may determine a received PPDU as an intra-BSS PPDU when the RA field value matches the address of the previous TXOP holder, or when the RA field value matches the BSSID of the currently associated BSS or the BSSID of another BSS within the same Multiple BSSID Set/Co-Hosted BSSID Set.

In addition, a wireless LAN terminal may determine a received PPDU as an inter-BSS PPDU when the “BSS_COLOR” value of the reception vector (RXVECTOR) is not 0 and differs from the BSS_COLOR value of the currently associated BSS. In addition, with respect to a VHT PPDU, a wireless LAN terminal may determine a received PPDU as an inter-BSS PPDU when the partial AID (PARTIAL_AID) value of the reception vector (RXVECTOR) differs from the BSSID of the currently associated BSS or the BSSID of another BSS within the same Multiple BSSID Set/Co-Hosted BSSID Set. In addition, a wireless LAN terminal may determine a received PPDU as an inter-BSS PPDU when the GROUP_ID of the reception vector (RXVECTOR) is 63 and the Partial BSS Color in the most recently received HE Operation Element is 1. In addition, a wireless LAN terminal may determine a received PPDU as an inter-BSS PPDU under VHT MU/HE MU PPDU conditions when the UPLINK_FLAG value of the reception vector (RXVECTOR) is 0 and the terminal receiving the PPDU is an AP. In addition, a wireless LAN terminal may determine a received PPDU as an inter-BSS PPDU under conditions related to the BSSID when the PPDU transmits a frame that does not match the BSSID and is not a Wildcard BSSID. In addition, a wireless LAN terminal may determine a received PPDU as an inter-BSS PPDU when the PPDU does not include a BSSID field but includes both RA and TA fields and these do not match the BSSID of the same BSS, but may not be limited thereto.

Here, a basic NAV may be set in a wireless LAN terminal when the PPDU received by the wireless LAN terminal does not correspond to either an intra-BSS PPDU or an inter-BSS PPDU. In an embodiment, in the case of a CTS frame containing only an RA field, if the RA field does not match the address of the previous TXOP holder, or does not match the address of the currently associated BSS or another BSS within the same Multiple BSSID Set/Co-Hosted BSSID Set, the frame may be considered as not belonging to either intra-BSS or inter-BSS, and the basic NAV may be set in such a case.

In FIG. 6, AP 2 (630) may be in a hidden node relationship with STA 1 (610), and since STA 1 (610) receives the CTS frame (603-1) wherein the RA field is set to AP 2 (630), the RA field does not match the address of the currently associated BSS or another BSS within the same Multiple BSSID Set/Co-Hosted BSSID Set, and therefore the basic NAV may be set. That is, since the AP to which STA 1 (610) is connected is AP 1 (620), upon receiving the CTS frame (603-1) wherein the RA field is set to AP 2 (630), the CTS frame cannot be determined to be an intra-BSS PPDU nor an inter-BSS PPDU, and therefore the basic NAV may be set.

In an embodiment, AP 3 (640) may not be able to receive the MU-RTS frame (602) of AP 2 (630), and AP 1 (620) may be able to receive the MU-RTS frame (602) of AP 2 (630). However, this is for convenience of explanation only and may not be limited thereto. AP 1 (620) may receive the MU-RTS frame (602) and transmit a CTS frame (603-1) to AP 2 (630). Since the CTS frame (603-1) transmitted in response to the MU-RTS frame (602) may be an S-CTS frame, AP 2 (630) may not be able to distinguish which AP transmitted the CTS frame. Accordingly, after receiving the CTS frame, AP 2 (630) may verify whether AP 3 (640) is performing communication during the communication period allocated to AP 3 (640). In an embodiment, when communication by AP 3 (640) is not detected until after a priority interframe space (PIFS) duration or longer from the time AP 2 (630) completes reception of the CTS frame, AP 2 (630) may reallocate the communication period. In an embodiment, when AP 2 (630) does not detect communication by AP 3 (640) for a PIFS duration from a specific point in time within the communication period allocated to AP 3 (640) (In an embodiment, the point at which AP 2 completes reception of the CTS frame), AP 2 (630) may retransmit the MU-RTS frame after a PIFS duration from the time AP 2 (630) completes reception of the CTS frame. Based on the aforementioned operations, AP 2 (630) may reallocate the communication period to AP 3 (640). Alternatively, AP 2 (630) may allocate the communication period to an AP other than AP 3 (640) that failed to receive a communication period allocation via the MU-RTS frame (In an embodiment, AP 1), and is not limited to any specific form.

The machine learning algorithm and machine learning unit operations illustrated in FIG. 1 through FIG. 4 may be used by AP 2 (630) to determine the target AP for C-TDMA communication. In an embodiment, AP 3 (640), to which AP 2 (630) allocates a C-TDMA communication period, may be the result determined by the machine learning unit of AP 2. In addition, the machine learning algorithm and machine learning unit operations illustrated in FIG. 1 through FIG. 4 may be used by AP 1 (620) to determine whether to transmit a CTS frame in response to transmission of the MU-RTS frame of AP 2 (630). In an embodiment, AP 1 (620) may use the machine learning unit to determine, with parameters such as the received power of frames as input, whether STA 1 is able to receive frames from AP 2 (630) and AP 3 (640) and set the NAV. When it is determined that STA 1 (610) is able to set the NAV, AP 1 (620) may determine not to transmit an unnecessary CTS frame. Conversely, when it is determined that STA 1 (610) is not able to set the NAV, AP 1 (620) may determine to transmit a CTS frame.

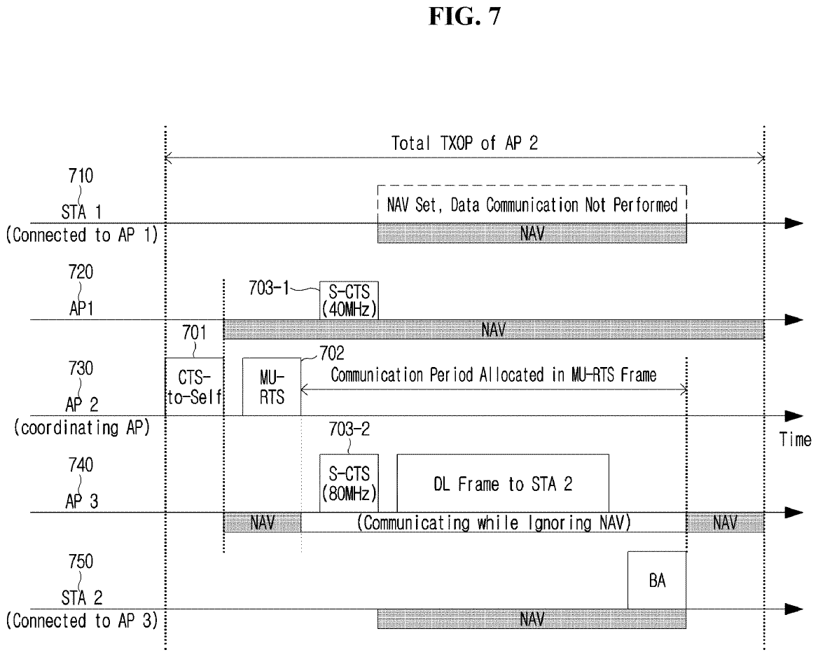

FIG. 7 is a diagram illustrating a method of protecting a communication period when a coordinated time-division communication operation is performed in a wireless LAN to which the present disclosure is applied.

Referring to FIG. 7, a plurality of access points (APs) may operate in a wireless LAN. In an embodiment, AP 1 through AP 3 (720, 730, 740) may operate in the wireless LAN. Here, AP 2 (730) may be a coordinating AP that coordinates a coordinated time division multiple access (C-TDMA) method. AP 2 (730) may establish a transmission opportunity (TXOP) on the channel in order to use C-TDMA. Here, the TXOP is a time interval during which a plurality of frames may be transmitted. The TXOP may be established via a CTS frame (In an embodiment, a CTS-to-Self frame wherein the receiver address is set to the MAC address of AP 2). In an embodiment, the TXOP may also be established via transmission of a multi-user request to send (MU-RTS) frame or a data frame. The following description is based on the case where the TXOP is established using a CTS-to-Self frame, but may not be limited thereto.

Referring to FIG. 7, AP 1 (720) and AP 3 (740) may receive the CTS-to-Self frame (or CTS frame, 701) transmitted by AP 2 (730), and may set a network allocation vector (NAV) based on the time length indicated by the duration field included in the medium access control (MAC) header of the CTS-to-Self frame (701). The NAV may be set to correspond to the length of the TXOP established by AP 2 (730). Here, STA 1 (710) connected to AP 1 (720) may be in a hidden node relationship with AP 2 (730), and STA 1 (710) may not be able to receive the CTS-to-Self frame (701) transmitted by AP 2 (730). Accordingly, STA 1 (710) may not be able to set the NAV.

In an embodiment, when the NAV is set in a wireless LAN terminal, wireless LAN terminals including APs and non-AP STAs (i.e., STAs) may detect the channel as busy based on virtual carrier sensing and may not be able to perform frame transmission. That is, when the NAV is set in a wireless LAN terminal, the wireless LAN terminal may wait without performing frame transmission. AP 2 (730) may transmit an MU-RTS frame (702) to allocate a C-TDMA communication period within the TXOP. The MU-RTS frame (702) may include a user information field containing information on AP 3 (740) (In an embodiment, the association identifier (AID) of AP 3) to which the C-TDMA communication period is to be allocated. In addition, the MU-RTS frame (702) may include information on AP 1 (720) that is capable of C-TDMA communication but has not been allocated a communication period. The information on AP 3 (740) and the information on AP 1 (720) may include information indicating the frequency at which the CTS frames (703-1, 703-2) are to be transmitted (In an embodiment, 20 MHz, 40 MHz, 80 MHz, 160 MHz, or 320 MHz). In an embodiment, AP 2 (730) may cause each AP to transmit a CTS frame on a different bandwidth in order to distinguish between the CTS frame transmissions of AP 3 (740) and AP 1 (720). As a specific embodiment, AP 3 (740), which is allocated the C-TDMA communication period, may be instructed to transmit the CTS frame (703-2) on a wider bandwidth (In an embodiment, 80 MHz), and AP 1 (720) may be instructed to transmit the CTS frame (703-1) on a relatively narrower bandwidth than AP 3 (740) (In an embodiment, 40 MHz).

That is, the AP allocated the C-TDMA communication period may be instructed to transmit the CTS frame on a wider bandwidth. In addition, the information within the MU-RTS frame (702) transmitted by AP 2 (730) may include at least one of an indicator indicating that AP 3 (740) is allocated the C-TDMA communication period and an indicator indicating that AP 1 (720) is not allocated the C-TDMA communication period.

AP 3 (740) may receive an allocation of the C-TDMA communication period and may transmit a CTS frame in response to the MU-RTS frame. In addition, AP 1 (720), although not allocated a C-TDMA communication period, may transmit a CTS frame as a response based on the information on AP 1 (720) included in the MU-RTS frame (702). The CTS frame transmitted in response to the MU-RTS frame (702) may be a simultaneous CTS frame. That is, it may be a CTS frame that a plurality of wireless LAN terminals may simultaneously transmit. In addition, since the CTS frame is an immediate response frame to the MU-RTS frame, it may be transmitted as a response even when the NAV is set.

In an embodiment, AP 3 (740) may communicate with a STA connected to AP 3 (740) (In an embodiment, STA 2 (750)) while ignoring the NAV set during the C-TDMA communication period, based on the allocated C-TDMA communication period (or shared TXOP). AP 3 (740) may transmit a downlink frame to STA 2 (750) or trigger uplink frame transmission. AP 3 (740) may transmit a trigger frame to STA 2 (750) to trigger uplink frame transmission by STA 2 (750). In an embodiment, the trigger frame transmitted to STA 2 (750) may have the CS required field set to 0. Accordingly, when STA 2 (750) receives the trigger frame, STA 2 (750) may transmit an uplink frame (In an embodiment, an uplink (UL) trigger-based (TB) physical layer protocol data unit (PPDU)) to AP 3 (740) regardless of whether the channel state detected by the NAV (i.e., virtual carrier sensing) or physical carrier sensing is in an idle state or a busy state. Here, since AP 3 (740) has been allocated a communication period from AP 2 (730), AP 3 (740) may transmit a trigger frame with the CS required bit set to 0 to STA 2 (750).

In an embodiment, STA 1 (710) may not be able to receive the MU-RTS frame (702) of AP 2 (730), but may be able to receive the CTS frame (703-1) of AP 1 (720). That is, as described above, AP 1 (720), which has not been allocated a C-TDMA communication period (or shared TXOP) from AP 2 (730), may transmit a CTS frame (703-1), and STA 1 (710) may receive the CTS frame (703-1) transmitted by AP 1 (720). Accordingly, STA 1 (710) may set the NAV for the time length indicated by the duration field included in the MAC header of the CTS frame (703-1) of AP 1 (720). That is, STA 1 (710) may not transmit a data frame to AP 1 (720) for the time length indicated by the duration field, thereby preventing interference with C-TDMA communication caused by frame transmission from STA 1 (710).

In an embodiment, since the CTS frame (703-1) transmitted by AP 1 (720) is transmitted to AP 2 (730), the receiver address (RA) field may be set to AP 2 (730). The RA field of the CTS frame (703-1) received by STA 1 (710) from AP 1 (720) may be AP 2 (730), and accordingly, a basic NAV may be set in STA 1 (710). That is, STA 1 (710) may set the basic NAV even though the CTS frame (703-1) is a frame transmitted by AP 1 (720) within the same BSS.

In an embodiment, the basic NAV may be set when the PPDU received by a wireless LAN terminal does not correspond to either an intra-BSS PPDU or an inter-BSS PPDU. Here, when a wireless LAN terminal receives a CTS frame, which is a control frame that includes only an RA field without a transmitter address (TA) field, the wireless LAN terminal may determine that the frame does not correspond to either an intra-BSS or inter-BSS frame if the RA field does not match the address of the previous TXOP holder, or does not match the address of the currently associated BSS or another BSS within the same Multiple BSSID Set/Co-Hosted BSSID Set.

More specifically, when a wireless LAN terminal receives a PPDU, the wireless LAN terminal may determine whether the PPDU is an intra-BSS PPDU or an inter-BSS PPDU. As a specific embodiment, a wireless LAN terminal may determine a received PPDU as an intra-BSS PPDU when the “BSS_COLOR” value of the reception vector (RXVECTOR) parameter of the received PPDU is 0 or is identical to the “BSS_COLOR” value of the currently associated BSS. In addition, with respect to a very high throughput (VHT) PPDU, a wireless LAN terminal may determine a received PPDU as an intra-BSS PPDU when the partial AID (PARTIAL_AID) value of the reception vector (RXVECTOR) of the received PPDU is identical to the BSSID of the currently associated BSS or the BSSID of another BSS within the same Multiple BSSID Set or Co-Hosted BSSID Set, and the GROUP_ID is 0. In addition, with respect to a CTS frame, which is a control frame containing only an RA field, a wireless LAN terminal may determine a received PPDU as an intra-BSS PPDU when the RA field value matches the address of the previous TXOP holder, or when the RA field value matches the BSSID of the currently associated BSS or the BSSID of another BSS within the same Multiple BSSID Set/Co-Hosted BSSID Set.

In addition, a wireless LAN terminal may determine a received PPDU as an inter-BSS PPDU when the “BSS_COLOR” value of the reception vector (RXVECTOR) is not 0 and differs from the BSS_COLOR value of the currently associated BSS. In addition, with respect to a VHT PPDU, a wireless LAN terminal may determine a received PPDU as an inter-BSS PPDU when the partial AID (PARTIAL_AID) value of the reception vector (RXVECTOR) differs from the BSSID of the currently associated BSS or the BSSID of another BSS within the same Multiple BSSID Set/Co-Hosted BSSID Set. In addition, a wireless LAN terminal may determine a received PPDU as an inter-BSS PPDU when the GROUP_ID of the reception vector (RXVECTOR) is 63 and the Partial BSS Color in the most recently received HE Operation Element is 1. In addition, a wireless LAN terminal may determine a received PPDU as an inter-BSS PPDU under VHT MU/HE MU PPDU conditions when the UPLINK_FLAG value of the reception vector (RXVECTOR) is 0 and the terminal receiving the PPDU is an AP. In addition, a wireless LAN terminal may determine a received PPDU as an inter-BSS PPDU under conditions related to the BSSID when the PPDU transmits a frame that does not match the BSSID and is not a Wildcard BSSID. In addition, a wireless LAN terminal may determine a received PPDU as an inter-BSS PPDU when the PPDU does not include a BSSID field but includes both RA and TA fields and these do not match the BSSID of the same BSS, but may not be limited thereto.

Here, a basic NAV may be set in a wireless LAN terminal when the PPDU received by the wireless LAN terminal does not correspond to either an intra-BSS PPDU or an inter-BSS PPDU. In an embodiment, in the case of a CTS frame containing only an RA field, if the RA field does not match the address of the previous TXOP holder, or does not match the address of the currently associated BSS or another BSS within the same Multiple BSSID Set/Co-Hosted BSSID Set, the frame may be considered as not belonging to either intra-BSS or inter-BSS, and the basic NAV may be set in such a case.

In FIG. 7, AP 2 (730) may be in a hidden node relationship with STA 1 (710), and since STA 1 (710) receives the CTS frame (703-1) wherein the RA field is set to AP 2 (730), the RA field does not match the address of the currently associated BSS or another BSS within the same Multiple BSSID Set/Co-Hosted BSSID Set, and therefore the basic NAV may be set. That is, since the AP to which STA 1 (710) is connected is AP 1 (720), upon receiving the CTS frame (703-1) wherein the RA field is set to AP 2 (730), the CTS frame cannot be determined to be an intra-BSS PPDU nor an inter-BSS PPDU, and therefore the basic NAV may be set.

In an embodiment, AP 3 (740) may not be able to receive the MU-RTS frame (702) of AP 2 (730), and AP 1 (720) may be able to receive the MU-RTS frame (702) of AP 2 (730). AP 1 (720) may receive the MU-RTS frame (702) and transmit a CTS frame (703-1) to AP 2 (730). Although the CTS frame transmitted in response to the MU-RTS frame (702) is an S-CTS frame, AP 2 (730) may be able to distinguish which AP transmitted the CTS frame because AP 1 (720) and AP 3 (740) transmit the CTS frames (703-1, 703-2) on different bandwidths. In an embodiment, AP 2 (730) may receive the CTS frame and verify the bandwidth of the CTS frame. As a specific embodiment, AP 3 (740) may not respond to the MU-RTS frame (702) of AP 2 (730) with a CTS frame, whereas AP 1 (720) may respond with a CTS frame. Here, since AP 3 (740) did not respond to the MU-RTS frame (702) of AP 2 (730), AP 2 (730) may not be able to allocate a communication period to AP 3 (740). Accordingly, AP 2 (730) may reallocate the communication period. In an embodiment, AP 2 (730) may retransmit the MU-RTS frame after a short interframe space (SIFS) or PIFS duration within the communication period allocated to AP 3 (740) (In an embodiment, from the point at which AP 2 (730) completes reception of the CTS frame). Through this, AP 2 (730) may allocate the communication period to an AP other than AP 3 (740) that failed to receive a communication period allocation (In an embodiment, AP 1 (720)).

The machine learning algorithm and machine learning unit operations illustrated in FIG. 1 through FIG. 4 may be used by AP 2 (730) to determine the target AP for C-TDMA communication. In an embodiment, AP 3 (740), to which AP 2 (730) allocates a C-TDMA communication period, may be the result determined by the machine learning unit of AP 2 (730). The determination of the transmission bandwidth of the CTS frame indicated in the user information field included in the MU-RTS frame transmitted by AP 2 (730) prior to allocating the C-TDMA communication period may be based on the machine learning algorithm and machine learning unit operations illustrated in FIG. 1 through FIG. 4. As a specific embodiment, AP 2 (730) may use the machine learning unit to determine the maximum bandwidth to be used in C-TDMA communication. Based on the determined maximum bandwidth, the CTS frame transmitted by an AP that is allocated the C-TDMA communication period may be instructed to be transmitted using the maximum bandwidth, and the CTS frame transmitted by an AP that is not allocated the C-TDMA communication period may be determined to be transmitted using a narrower bandwidth than the CTS frame transmitted by the AP that is allocated the C-TDMA communication period.

The machine learning algorithm and machine learning unit operations illustrated in FIG. 1 through FIG. 4 may also be used in the operation of AP 1 (720) determining whether to transmit a CTS frame in response to transmission of the MU-RTS frame of AP 2 (730). In an embodiment, AP 1 (720) may use the machine learning unit to determine, with parameters such as the received power of frames as input, whether STA 1 (710) is able to receive frames from AP 2 (730) and AP 3 (740) and set the NAV. When it is determined that STA 1 (710) is able to set the NAV, AP 1 (720) may determine not to transmit an unnecessary CTS frame. Conversely, when it is determined that STA 1 (710) is not able to set the NAV, AP 1 (720) may determine to transmit a CTS frame.

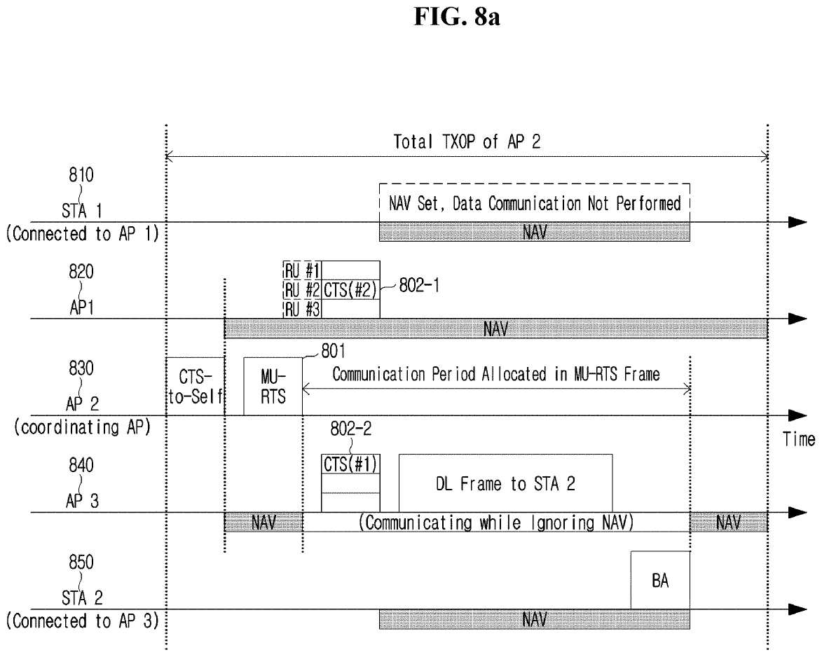

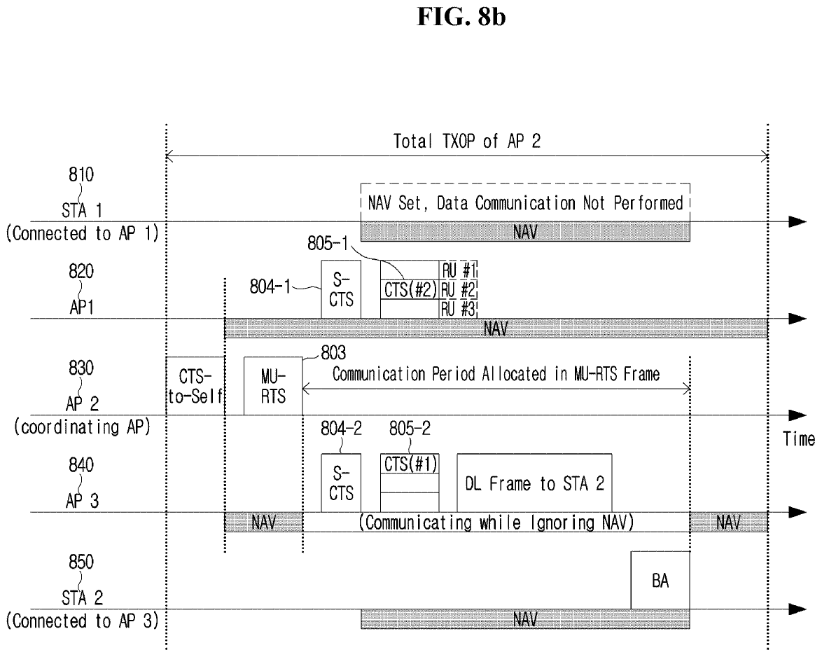

FIG. 8a and FIG. 8b are diagrams illustrating a method of protecting a communication period when a coordinated time-division communication operation is performed in a wireless LAN to which the present disclosure is applied.

Referring to FIG. 8a and FIG. 8b, a plurality of access points (APs) may operate in a wireless LAN. In an embodiment, AP 1 through AP 3 (820, 830, 840) may operate in the wireless LAN. Here, AP 2 (830) may be a coordinating AP that coordinates a coordinated time division multiple access (C-TDMA) method. AP 2 (830) may establish a transmission opportunity (TXOP) on the channel in order to use C-TDMA. Here, the TXOP is a time interval during which a plurality of frames may be transmitted. The TXOP may be established via a CTS frame (In an embodiment, a CTS-to-Self frame wherein the receiver address is set to the MAC address of AP 2). In an embodiment, the TXOP may also be established via transmission of a multi-user request to send (MU-RTS) frame or a data frame. The following description is based on the case where the TXOP is established using a CTS-to-Self frame, but may not be limited thereto.

Referring to FIG. 8a and FIG. 8b, AP 1 (820) and AP 3 (840) may receive the CTS-to-Self frame (or CTS frame) transmitted by AP 2 (830), and may set a network allocation vector (NAV) based on the time length indicated by the duration field included in the medium access control (MAC) header of the CTS-to-Self frame. The NAV may be set to correspond to the length of the TXOP established by AP 2 (830). Here, STA 1 (810) connected to AP 1 (820) may be in a hidden node relationship with AP 2 (830), and STA 1 (810) connected to AP 1 (820) may not be able to receive the CTS-to-Self frame of AP 2 (830). Accordingly, STA 1 (810) may not be able to set the NAV.

In an embodiment, when the NAV is set in a wireless LAN terminal, wireless LAN terminals including APs and non-AP STAs (i.e., STAs) may detect the channel as busy based on virtual carrier sensing and may not be able to perform frame transmission. That is, when the NAV is set in a wireless LAN terminal, the wireless LAN terminal may wait without performing frame transmission. AP 2 (830) may transmit an MU-RTS frame (801) to allocate a C-TDMA communication period within the TXOP. The MU-RTS frame (801) may include a user information field containing information on AP 3 (840) (In an embodiment, the association identifier (AID) of AP 3) to which the C-TDMA communication period is to be allocated, as well as information on AP 1 (820) that is capable of C-TDMA communication but has not been allocated a communication period.

Referring to FIG. 8a, the information on AP 3 (840) and the information on AP 1 (820) included in the MU-RTS frame may include information indicating the frequency at which the CTS frame is to be transmitted (In an embodiment, an orthogonal frequency division multiple access (OFDMA) resource unit (RU)). In an embodiment, AP 2 (830) may cause each AP to transmit a CTS frame on a different RU in order to distinguish between the CTS frame transmissions of AP 3 (840) and AP 1 (820). As a specific embodiment, AP 3 (840), which is allocated the C-TDMA communication period, may transmit the CTS frame (802-2) on RU #1, and AP 1 (820) may transmit the CTS frame (802-1) on RU #2. In addition, the information of the MU-RTS frame (801) transmitted by AP 2 (830) may include at least one of an indicator indicating that AP 3 (840) is allocated the C-TDMA communication period and an indicator indicating that AP 1 (820) is not allocated the C-TDMA communication period.

In an embodiment, AP 3 (840) may receive an allocation of the C-TDMA communication period and may transmit a CTS frame (802-2) to AP 2 (830) in response to the MU-RTS frame (801). AP 1 (820) may not be allocated a C-TDMA communication period, but may transmit a CTS frame as a response based on the information on AP 1 (820) included in the MU-RTS frame (801). The CTS frames (802-1, 802-2) transmitted by AP 1 (820) and AP 3 (840) in response to the MU-RTS frame (801) may be trigger-based (TB) PPDUs. Here, since the CTS frames (802-1, 802-2) of AP 1 (820) and AP 3 (840) are transmitted on different frequencies, AP 2 (830) may be aware of which AP responded. Since the CTS frame is an immediate response frame to the MU-RTS frame, it may be transmitted as a response even when the NAV is set.

In an embodiment, AP 3 (840) may communicate with a STA connected to AP 3 (840) (In an embodiment, STA 2 (850)) while ignoring the NAV set during the C-TDMA communication period, based on the allocated C-TDMA communication period (or shared TXOP). AP 3 (840) may transmit a downlink frame to STA 2 (850) or trigger uplink frame transmission. AP 3 (840) may transmit a trigger frame to STA 2 (850) to trigger uplink frame transmission by STA 2 (850). In an embodiment, the trigger frame transmitted to STA 2 (850) may have the CS required field set to 0. Accordingly, when STA 2 (850) receives the trigger frame, STA 2 (850) may transmit an uplink frame (In an embodiment, an uplink (UL) trigger-based (TB) physical layer protocol data unit (PPDU)) to AP 3 (840) regardless of whether the channel state detected by the NAV (i.e., virtual carrier sensing) or physical carrier sensing is in an idle state or a busy state. Here, since AP 3 (840) has been allocated a communication period from AP 2 (830), AP 3 (840) may transmit a trigger frame with the CS required bit set to 0 to STA 2 (850).

In an embodiment, STA 1 (810) may not be able to receive the MU-RTS frame (801) of AP 2 (830), but may be able to receive the CTS frame (802-1) of AP 1 (820). That is, as described above, AP 1 (820), which has not been allocated a C-TDMA communication period (or shared TXOP) from AP 2 (830), may transmit a CTS frame (802-1), and STA 1 (810) may receive the CTS frame (802-1) transmitted by AP 1 (820). Accordingly, STA 1 (810) may set the NAV for the time length indicated by the duration field included in the MAC header of the CTS frame (802-1) of AP 1 (820). That is, STA 1 (810) may not transmit a data frame to AP 1 (820) for the time length indicated by the duration field, thereby preventing interference with C-TDMA communication caused by frame transmission from STA 1 (810).

In an embodiment, since the CTS frame (803-1) transmitted by AP 1 (820) is transmitted to AP 2 (830), the receiver address (RA) field may be set to AP 2 (830). The RA field of the CTS frame (802-1) received by STA 1 (810) from AP 1 (820) may be AP 2 (830), and accordingly, a basic NAV may be set in STA 1 (810). That is, STA 1 (810) may set the basic NAV even though the CTS frame (802-1) is a frame transmitted by AP 1 (820) within the same BSS.

In an embodiment, the basic NAV may be set when the PPDU received by a wireless LAN terminal does not correspond to either an intra-BSS PPDU or an inter-BSS PPDU. Here, when a wireless LAN terminal receives a CTS frame, which is a control frame that includes only an RA field without a transmitter address (TA) field, the wireless LAN terminal may determine that the frame does not correspond to either an intra-BSS or inter-BSS frame if the RA field does not match the address of the previous TXOP holder, or does not match the address of the currently associated BSS or another BSS within the same Multiple BSSID Set/Co-Hosted BSSID Set.

More specifically, when a wireless LAN terminal receives a PPDU, the wireless LAN terminal may determine whether the PPDU is an intra-BSS PPDU or an inter-BSS PPDU. As a specific embodiment, a wireless LAN terminal may determine a received PPDU as an intra-BSS PPDU when the “BSS_COLOR” value of the reception vector (RXVECTOR) parameter of the received PPDU is 0 or is identical to the “BSS_COLOR” value of the currently associated BSS. In addition, with respect to a very high throughput (VHT) PPDU, a wireless LAN terminal may determine a received PPDU as an intra-BSS PPDU when the partial AID (PARTIAL_AID) value of the reception vector (RXVECTOR) of the received PPDU is identical to the BSSID of the currently associated BSS or the BSSID of another BSS within the same Multiple BSSID Set or Co-Hosted BSSID Set, and the GROUP_ID is 0. In addition, with respect to a CTS frame, which is a control frame containing only an RA field, a wireless LAN terminal may determine a received PPDU as an intra-BSS PPDU when the RA field value matches the address of the previous TXOP holder, or when the RA field value matches the BSSID of the currently associated BSS or the BSSID of another BSS within the same Multiple BSSID Set/Co-Hosted BSSID Set.

In addition, a wireless LAN terminal may determine a received PPDU as an inter-BSS PPDU when the “BSS_COLOR” value of the reception vector (RXVECTOR) is not 0 and differs from the BSS_COLOR value of the currently associated BSS. In addition, with respect to a VHT PPDU, a wireless LAN terminal may determine a received PPDU as an inter-BSS PPDU when the partial AID (PARTIAL_AID) value of the reception vector (RXVECTOR) differs from the BSSID of the currently associated BSS or the BSSID of another BSS within the same Multiple BSSID Set/Co-Hosted BSSID Set. In addition, a wireless LAN terminal may determine a received PPDU as an inter-BSS PPDU when the GROUP_ID of the reception vector (RXVECTOR) is 63 and the Partial BSS Color in the most recently received HE Operation Element is 1. In addition, a wireless LAN terminal may determine a received PPDU as an inter-BSS PPDU under VHT MU/HE MU PPDU conditions when the UPLINK_FLAG value of the reception vector (RXVECTOR) is 0 and the terminal receiving the PPDU is an AP. In addition, a wireless LAN terminal may determine a received PPDU as an inter-BSS PPDU under conditions related to the BSSID when the PPDU transmits a frame that does not match the BSSID and is not a Wildcard BSSID. In addition, a wireless LAN terminal may determine a received PPDU as an inter-BSS PPDU when the PPDU does not include a BSSID field but includes both RA and TA fields and these do not match the BSSID of the same BSS, but may not be limited thereto.

Here, a basic NAV may be set in a wireless LAN terminal when the PPDU received by the wireless LAN terminal does not correspond to either an intra-BSS PPDU or an inter-BSS PPDU. In an embodiment, in the case of a CTS frame containing only an RA field, if the RA field does not match the address of the previous TXOP holder, or does not match the address of the currently associated BSS or another BSS within the same Multiple BSSID Set/Co-Hosted BSSID Set, the frame may be considered as not belonging to either intra-BSS or inter-BSS, and the basic NAV may be set in such a case.

In FIG. 8a, AP 2 (830) may be in a hidden node relationship with STA 1 (810), and since STA 1 (810) receives the CTS frame (802-1) wherein the RA field is set to AP 2 (830), the RA field does not match the address of the currently associated BSS or another BSS within the same Multiple BSSID Set/Co-Hosted BSSID Set, and therefore the basic NAV may be set. That is, since the AP to which STA 1 (810) is connected is AP 1 (820), upon receiving the CTS frame (803-1) wherein the RA field is set to AP 2 (830), the CTS frame cannot be determined to be an intra-BSS PPDU nor an inter-BSS PPDU, and therefore the basic NAV may be set.

In an embodiment, AP 3 (840) may not be able to receive the MU-RTS frame (801) of AP 2 (830), and AP 1 (820) may be able to receive the MU-RTS frame (801) of AP 2 (830). AP 1 (820) may receive the MU-RTS frame (801) and transmit a CTS frame (802-1) to AP 2 (830). AP 1 (820) and AP 3 (840) may transmit the CTS frames (802-1, 802-2) in response to the MU-RTS frame (801) using different frequencies (In an embodiment, different RUs). Accordingly, AP 2 (830) may be able to distinguish which AP transmitted the CTS frame.

In an embodiment, AP 2 (830) may receive the CTS frame and, based on the frequency at which the CTS frame is transmitted, may verify that AP 1 (820) transmitted the CTS frame (802-1) and that AP 3 (840) did not transmit the CTS frame (802-2). Here, since AP 3 (840) did not respond to the MU-RTS frame (801) of AP 2 (830), AP 2 (830) may not be able to allocate a communication period to AP 3 (840). Accordingly, AP 2 (830) may reallocate the communication period. In an embodiment, AP 2 (830) may retransmit the MU-RTS frame after a short interframe space (SIFS) or PIFS duration within the communication period allocated to AP 3 (840) (In an embodiment, from the point at which AP 2 (830) completes reception of the CTS frame). Through this, AP 2 (830) may allocate the communication period to an AP other than AP 3 (840) that failed to receive a communication period allocation (In an embodiment, AP 1 (820)).

Referring to FIG. 8B, the information on AP 3 (840) and the information on AP 1 (820) included in the MU-RTS frame (803) may include information indicating the frequency at which the CTS frame is to be transmitted (In an embodiment, an orthogonal frequency division multiple access (OFDMA) resource unit (RU)). In an embodiment, AP 2 (830) may cause each AP to transmit a CTS frame on a different RU in order to distinguish between the CTS frame transmissions of AP 3 (840) and AP 1 (820). As a specific embodiment, AP 3 (840), which is allocated the C-TDMA communication period, may transmit the CTS frame (805-2) on RU #1, and AP 1 (820) may transmit the CTS frame (805-1) on RU #2. In addition, the information of the MU-RTS frame (803) transmitted by AP 2 (830) may include at least one of an indicator indicating that AP 3 (840) is allocated the C-TDMA communication period and an indicator indicating that AP 1 (820) is not allocated the C-TDMA communication period.

In an embodiment, AP 3 (840) may receive an allocation of the C-TDMA communication period and may transmit a CTS frame to AP 2 (830) in response to the MU-RTS frame (803). AP 1 (820) may not be allocated a C-TDMA communication period, but may transmit a CTS frame as a response based on the information on AP 1 (820) included in the MU-RTS frame (803).

AP 1 (820) and AP 3 (840) may transmit simultaneous CTS (S-CTS) frames (804-1, 804-2) in response to the MU-RTS frame (803). That is, AP 1 (820) and AP 3 (840) may first transmit CTS frames (804-1, 804-2) using a wide bandwidth. After AP 1 (820) and AP 3 (840) complete transmission of the CTS frames (804-1, 804-2), AP 1 (820) and AP 3 (840) may retransmit the CTS frames (805-1, 805-2) on the RU allocated by AP 2 (830). The CTS frames of AP 1 (820) and AP 3 (840) may be trigger-based (TB) PPDUs. Here, since the CTS frames (805-1, 805-2) transmitted by AP 1 (820) and AP 3 (840) are transmitted on different frequencies, AP 2 (830) may be aware of which AP responded. Since the CTS frame is an immediate response frame to the MU-RTS frame, it may be transmitted as a response even when the NAV is set.

In an embodiment, AP 1 (820) and AP 3 (840) may transmit a quality of service (QoS) Null frame instead of the CTS frame transmitted as a TB PPDU. AP 2 (830) may be aware of which AP responded by checking the transmitter address and RU location of the QoS Null frame.

In an embodiment, AP 3 (840) may communicate with a STA connected to AP 3 (840) (In an embodiment, STA 2 (850)) while ignoring the NAV set during the C-TDMA communication period, based on the allocated C-TDMA communication period (or shared TXOP). AP 3 (840) may transmit a downlink frame to STA 2 (850) or trigger uplink frame transmission. AP 3 (840) may transmit a trigger frame to STA 2 (850) to trigger uplink frame transmission by STA 2 (850). In an embodiment, the trigger frame transmitted to STA 2 (850) may have the CS required field set to 0. Accordingly, when STA 2 (850) receives the trigger frame, STA 2 (850) may transmit an uplink frame (In an embodiment, an uplink (UL) trigger-based (TB) physical layer protocol data unit (PPDU)) to AP 3 (840) regardless of whether the channel state detected by the NAV (i.e., virtual carrier sensing) or physical carrier sensing is in an idle state or a busy state. Here, since AP 3 (840) has been allocated a communication period from AP 2 (830), AP 3 (840) may transmit a trigger frame with the CS required bit set to 0 to STA 2 (850).

In an embodiment, STA 1 (810) may not be able to receive the MU-RTS frame (803) of AP 2 (830), but may be able to receive the CTS frame of AP 1 (820). That is, as described above, AP 1 (820), which has not been allocated a C-TDMA communication period (or shared TXOP) from AP 2 (830), may transmit a CTS frame, and STA 1 (810) may receive the CTS frame transmitted by AP 1 (820). Accordingly, STA 1 (810) may set the NAV for the time length indicated by the duration field included in the MAC header of the CTS frame of AP 1 (820). That is, STA 1 (810) may not transmit a data frame to AP 1 (820) for the time length indicated by the duration field, thereby preventing interference with C-TDMA communication caused by frame transmission from STA 1 (810).

In an embodiment, since the CTS frame transmitted by AP 1 (820) is transmitted to AP 2 (830), the receiver address (RA) field may be set to AP 2 (830). The RA field of the CTS frame received by STA 1 (810) from AP 1 (820) may be AP 2 (830), and accordingly, a basic NAV may be set in STA 1 (810). That is, STA 1 (810) may set the basic NAV even though the CTS frame is a frame transmitted by AP 1 (820) within the same BSS.

In an embodiment, the basic NAV may be set when the PPDU received by a wireless LAN terminal does not correspond to either an intra-BSS PPDU or an inter-BSS PPDU. Here, when a wireless LAN terminal receives a CTS frame, which is a control frame that includes only an RA field without a transmitter address (TA) field, the wireless LAN terminal may determine that the frame does not correspond to either an intra-BSS or inter-BSS frame if the RA field does not match the address of the previous TXOP holder, or does not match the address of the currently associated BSS or another BSS within the same Multiple BSSID Set/Co-Hosted BSSID Set.

More specifically, when a wireless LAN terminal receives a PPDU, the wireless LAN terminal may determine whether the PPDU is an intra-BSS PPDU or an inter-BSS PPDU. As a specific embodiment, a wireless LAN terminal may determine a received PPDU as an intra-BSS PPDU when the “BSS_COLOR” value of the reception vector (RXVECTOR) parameter of the received PPDU is 0 or is identical to the “BSS_COLOR” value of the currently associated BSS. In addition, with respect to a very high throughput (VHT) PPDU, a wireless LAN terminal may determine a received PPDU as an intra-BSS PPDU when the partial AID (PARTIAL_AID) value of the reception vector (RXVECTOR) of the received PPDU is identical to the BSSID of the currently associated BSS or the BSSID of another BSS within the same Multiple BSSID Set or Co-Hosted BSSID Set, and the GROUP_ID is 0. In addition, with respect to a CTS frame, which is a control frame containing only an RA field, a wireless LAN terminal may determine a received PPDU as an intra-BSS PPDU when the RA field value matches the address of the previous TXOP holder, or when the RA field value matches the BSSID of the currently associated BSS or the BSSID of another BSS within the same Multiple BSSID Set/Co-Hosted BSSID Set.

In addition, a wireless LAN terminal may determine a received PPDU as an inter-BSS PPDU when the “BSS_COLOR” value of the reception vector (RXVECTOR) is not 0 and differs from the BSS_COLOR value of the currently associated BSS. In addition, with respect to a VHT PPDU, a wireless LAN terminal may determine a received PPDU as an inter-BSS PPDU when the partial AID (PARTIAL_AID) value of the reception vector (RXVECTOR) differs from the BSSID of the currently associated BSS or the BSSID of another BSS within the same Multiple BSSID Set/Co-Hosted BSSID Set. In addition, a wireless LAN terminal may determine a received PPDU as an inter-BSS PPDU when the GROUP_ID of the reception vector (RXVECTOR) is 63 and the Partial BSS Color in the most recently received HE Operation Element is 1. In addition, a wireless LAN terminal may determine a received PPDU as an inter-BSS PPDU under VHT MU/HE MU PPDU conditions when the UPLINK_FLAG value of the reception vector (RXVECTOR) is 0 and the terminal receiving the PPDU is an AP. In addition, a wireless LAN terminal may determine a received PPDU as an inter-BSS PPDU under conditions related to the BSSID when the PPDU transmits a frame that does not match the BSSID and is not a Wildcard BSSID. In addition, a wireless LAN terminal may determine a received PPDU as an inter-BSS PPDU when the PPDU does not include a BSSID field but includes both RA and TA fields and these do not match the BSSID of the same BSS, but may not be limited thereto.

Here, a basic NAV may be set in a wireless LAN terminal when the PPDU received by the wireless LAN terminal does not correspond to either an intra-BSS PPDU or an inter-BSS PPDU. In an embodiment, in the case of a CTS frame containing only an RA field, if the RA field does not match the address of the previous TXOP holder, or does not match the address of the currently associated BSS or another BSS within the same Multiple BSSID Set/Co-Hosted BSSID Set, the frame may be considered as not belonging to either intra-BSS or inter-BSS, and the basic NAV may be set in such a case.

In FIG. 8B, AP 2 (830) may be in a hidden node relationship with STA 1 (810), and since STA 1 (810) receives the CTS frame wherein the RA field is set to AP 2 (830), the RA field does not match the address of the currently associated BSS or another BSS within the same Multiple BSSID Set/Co-Hosted BSSID Set, and therefore the basic NAV may be set. That is, since the AP to which STA 1 (810) is connected is AP 1 (820), upon receiving the CTS frame (803-1) wherein the RA field is set to AP 2 (830), the CTS frame cannot be determined to be an intra-BSS PPDU nor an inter-BSS PPDU, and therefore the basic NAV may be set.

In an embodiment, AP 3 (840) may not be able to receive the MU-RTS frame (803) of AP 2 (830), and AP 1 (820) may be able to receive the MU-RTS frame (803) of AP 2 (830). AP 1 (820) may receive the MU-RTS frame (803) and transmit a CTS frame to AP 2 (830). AP 1 (820) and AP 3 (840) may transmit the CTS frames in response to the MU-RTS frame using different frequencies (In an embodiment, different RUs). Accordingly, AP 2 (830) may be able to distinguish which AP transmitted the CTS frame.

In an embodiment, AP 2 (830) may receive the CTS frame and, based on the frequency at which the CTS frame is transmitted, may verify that AP 1 (820) transmitted the CTS frame and that AP 3 (840) did not transmit the CTS frame. Here, since AP 3 (840) did not respond to the MU-RTS frame of AP 2 (830), AP 2 (830) may not be able to allocate a communication period to AP 3 (840). Accordingly, AP 2 (830) may reallocate the communication period. In an embodiment, AP 2 (830) may retransmit the MU-RTS frame after a short interframe space (SIFS) or PIFS duration within the communication period allocated to AP 3 (840) (In an embodiment, from the point at which AP 2 (830) completes reception of the CTS frame). Through this, AP 2 (830) may allocate the communication period to an AP other than AP 3 (840) that failed to receive a communication period allocation (In an embodiment, AP 1 (820)).

In FIG. 8a and FIG. 8b, the machine learning algorithm and machine learning unit operations illustrated in FIG. 1 through FIG. 4 may be used by AP 2 (830) to determine the target AP for C-TDMA communication. In an embodiment, AP 3 (840), to which AP 2 (830) allocates a C-TDMA communication period, may be the result determined by the machine learning unit of AP 2 (830). The determination of the transmission frequency of the CTS frame (In an embodiment, RU or OFDMA RU) indicated in the user information field included in the MU-RTS frame transmitted by AP 2 (830) prior to allocating the C-TDMA communication period may be based on the machine learning algorithm and machine learning unit operations illustrated in FIG. 1 through FIG. 4. In an embodiment, AP 2 (830) may use the machine learning unit to determine the maximum bandwidth to be used in C-TDMA communication. Based on the determined maximum bandwidth, the CTS frame transmitted by an AP that is allocated the C-TDMA communication period may be instructed to be transmitted using the maximum bandwidth, and the CTS frame transmitted by an AP that is not allocated the C-TDMA communication period may be determined to be transmitted using a different frequency and bandwidth from the CTS frame transmitted by the AP that is allocated the C-TDMA communication period.

The machine learning algorithm and machine learning unit operations illustrated in FIG. 1 through FIG. 4 may also be used in the operation of AP 1 (820) determining whether to transmit a CTS frame in response to transmission of the MU-RTS frame of AP 2 (830). In an embodiment, AP 1 (820) may use the machine learning unit to determine, with parameters such as the received power of frames as input, whether STA 1 is able to receive frames from AP 2 and AP 3 and set the NAV. When it is determined that STA 1 is able to set the NAV, AP 1 (820) may determine not to transmit an unnecessary CTS frame. Conversely, when it is determined that STA 1 is not able to set the NAV, AP 1 (820) may determine to transmit a CTS frame.

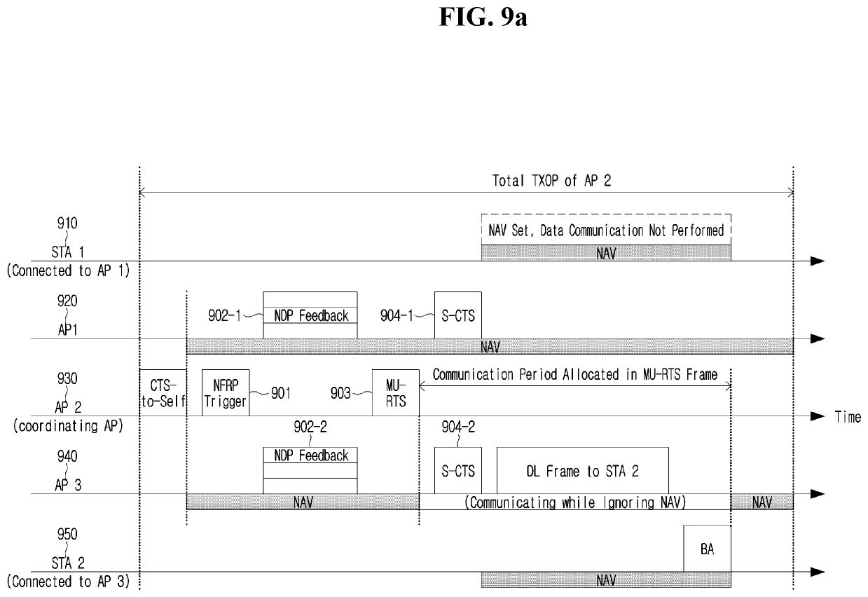

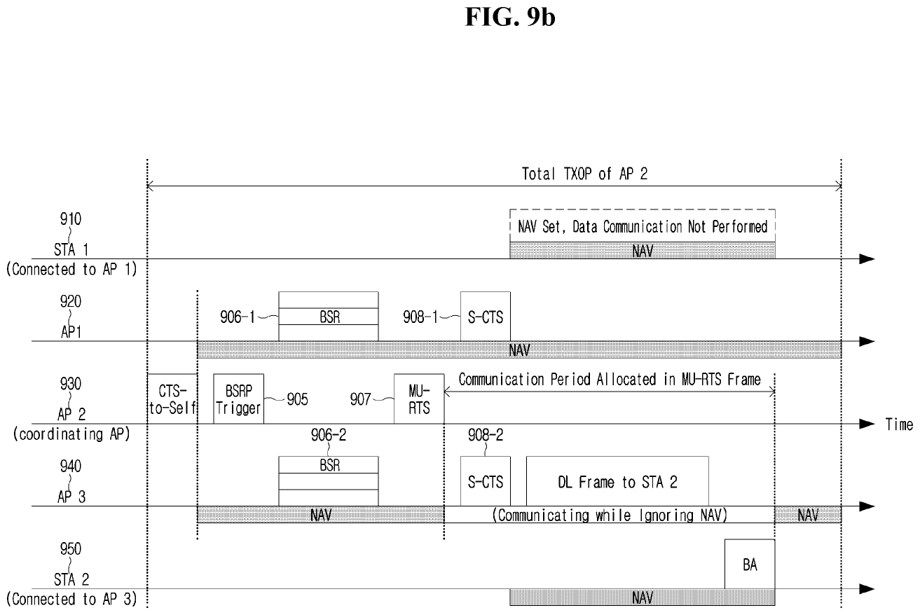

FIG. 9a and FIG. 9b are diagrams illustrating a method of protecting a communication period when a coordinated time-division communication operation is performed in a wireless LAN to which the present disclosure is applied.

Referring to FIG. 9a and FIG. 9b, a plurality of access points (APs) may operate in a wireless LAN. In an embodiment, AP 1 through AP 3 (920, 930, 940) may operate in the wireless LAN. Here, AP 2 (930) may be a coordinating AP that coordinates a coordinated time division multiple access (C-TDMA) method. AP 2 (930) may establish a transmission opportunity (TXOP) on the channel in order to use C-TDMA. Here, the TXOP is a time interval during which a plurality of frames may be transmitted. The TXOP may be established via a CTS frame (In an embodiment, a CTS-to-Self frame that the receiver address is set to the MAC address of AP 2). In an embodiment, the TXOP may also be established via transmission of a multi-user request to send (MU-RTS) frame or a data frame. The following description is based on the case where the TXOP is established using a CTS-to-Self frame, but may not be limited thereto.

Referring to FIG. 9a and FIG. 9b, AP 1 (920) and AP 3 (940) may receive the CTS-to-Self frame (or CTS frame) transmitted by AP 2 (930), and may set a network allocation vector (NAV) based on the time length indicated by the duration field included in the medium access control (MAC) header of the CTS-to-Self frame. The NAV may be set to correspond to the length of the TXOP established by AP 2 (930). Here, STA 1 (910) connected to AP 1 (920) may be in a hidden node relationship with AP 2 (930), and STA 1 (910) connected to AP 1 (920) may not be able to receive the CTS-to-Self frame of AP 2 (930). Accordingly, STA 1 (910) may not be able to set the NAV.

In an embodiment, when the NAV is set in a wireless LAN terminal, wireless LAN terminals including APs and non-AP STAs (i.e., STAs) may detect the channel as busy based on virtual carrier sensing and may not be able to perform frame transmission. That is, when the NAV is set in a wireless LAN terminal, the wireless LAN terminal may wait without performing frame transmission. AP 2 (930) may transmit an MU-RTS frame (903) to allocate a C-TDMA communication period within the TXOP. The MU-RTS frame (903) may include a user information field containing information on AP 3 (940) (In an embodiment, the association identifier (AID) of AP 3) to which the C-TDMA communication period is to be allocated, as well as information on AP 1 (920) that is capable of C-TDMA communication but has not been allocated a communication period.

Referring to FIG. 9a, prior to transmitting the MU-RTS frame (903) to allocate the C-TDMA communication period, AP 2 (930) may transmit an NDP (null data PPDU) Feedback Report Poll (NFRP) trigger frame (901). The NFRP trigger frame (901) may be a frame that requests feedback (In an embodiment, requests an NDP Feedback) to confirm whether a target AP for communication exists. The NFRP trigger frame (901) may include a dedicated AID starting index, through which APs may be identified. Upon receiving the NFRP trigger frame (901) transmitted by AP 2 (930), AP 1 (920) and AP 3 (940) may transmit NDP feedback reports (902-1, 902-2) as a response. The NDP feedback reports (902-1, 902-2) are frames consisting only of a PHY preamble and may be transmitted per OFDMA subcarrier tone. In an embodiment, dedicated AIDs identifying AP 1 (920) and AP 3 (940) may be designated, and AP 1 (920) and AP 3 (940) may transmit the NDP feedback reports (902-1, 902-2) on the OFDMA tone corresponding to the dedicated AID. AP 2 (930) may be aware of which AP responded through the received NDP feedback reports.

Here, in an embodiment, the AP to which AP 2 (930) intends to allocate a C-TDMA communication period may be AP 3 (940). However, this is for convenience of explanation only and may not be limited thereto. AP 2 (930) may verify whether AP 3 (940) responded to the NFRP trigger frame (901) transmitted by AP 2 (930). When AP 3 (940) has responded, AP 2 (930) may transmit the MU-RTS frame (903) that allocates the C-TDMA communication period to AP 3 (940). AP 3 (940), which is allocated the C-TDMA communication period, may transmit a CTS frame (904-2) in response to the MU-RTS frame (903) of AP 2 (930). In addition, AP 1 (920), which has not been allocated a C-TDMA communication period but is able to receive the MU-RTS frame (903), may transmit a CTS frame (904-1) in response to the MU-RTS frame (903) of AP 2 (930). Here, the CTS frames transmitted by AP 1 (920) and AP 3 (940) may be S-CTS frames. Since the CTS frame is an immediate response frame to the MU-RTS frame, it may be transmitted as a response even when the NAV is set.

In an embodiment, AP 3 (940) may communicate with a STA connected to AP 3 (940) (In an embodiment, STA 2 (950)) while ignoring the NAV set during the C-TDMA communication period, based on the allocated C-TDMA communication period (or shared TXOP). AP 3 (940) may transmit a downlink frame to STA 2 (950) or trigger uplink frame transmission. AP 3 (940) may transmit a trigger frame to STA 2 (950) to trigger uplink frame transmission by STA 2 (950). In an embodiment, the trigger frame transmitted to STA 2 (950) may have the CS required field set to 0. Accordingly, when STA 2 (950) receives the trigger frame, STA 2 (950) may transmit an uplink frame (In an embodiment, an uplink (UL) trigger-based (TB) physical layer protocol data unit (PPDU)) to AP 3 (940) regardless of whether the channel state detected by the NAV (i.e., virtual carrier sensing) or physical carrier sensing is in an idle state or a busy state. Here, since AP 3 (940) has been allocated a communication period from AP 2 (930), AP 3 (940) may transmit a trigger frame with the CS required bit set to 0 to STA 2 (950).

In an embodiment, STA 1 (910) may not be able to receive the MU-RTS frame (903) of AP 2 (930), but may be able to receive the CTS frame (904-1) of AP 1 (920). That is, as described above, AP 1 (920), which has not been allocated a C-TDMA communication period (or shared TXOP) from AP 2 (930), may transmit a CTS frame (904-1), and STA 1 (910) may receive the CTS frame (904-1) transmitted by AP 1 (920). Accordingly, STA 1 (910) may set the NAV for the time length indicated by the duration field included in the MAC header of the CTS frame (904-1) of AP 1 (920). That is, STA 1 (910) may not transmit a data frame to AP 1 (920) for the time length indicated by the duration field, thereby preventing interference with C-TDMA communication caused by frame transmission from STA 1 (910).

In an embodiment, since the CTS frame (904-1) transmitted by AP 1 (920) is transmitted to AP 2 (930), the receiver address (RA) field may be set to AP 2 (930). The RA field of the CTS frame (904-1) received by STA 1 (910) from AP 1 (920) may be AP 2 (930), and accordingly, a basic NAV may be set in STA 1 (910). That is, STA 1 (910) may set the basic NAV even though the CTS frame (904-1) is a frame transmitted by AP 1 (920) within the same BSS.

In an embodiment, the basic NAV may be set when the PPDU received by a wireless LAN terminal does not correspond to either an intra-BSS PPDU or an inter-BSS PPDU. Here, when a wireless LAN terminal receives a CTS frame, which is a control frame that includes only an RA field without a transmitter address (TA) field, the wireless LAN terminal may determine that the frame does not correspond to either an intra-BSS or inter-BSS frame if the RA field does not match the address of the previous TXOP holder, or does not match the address of the currently associated BSS or another BSS within the same Multiple BSSID Set/Co-Hosted BSSID Set.

More specifically, when a wireless LAN terminal receives a PPDU, the wireless LAN terminal may determine whether the PPDU is an intra-BSS PPDU or an inter-BSS PPDU. As a specific embodiment, a wireless LAN terminal may determine a received PPDU as an intra-BSS PPDU when the “BSS_COLOR” value of the reception vector (RXVECTOR) parameter of the received PPDU is 0 or is identical to the “BSS_COLOR” value of the currently associated BSS. In addition, with respect to a very high throughput (VHT) PPDU, a wireless LAN terminal may determine a received PPDU as an intra-BSS PPDU when the partial AID (PARTIAL_AID) value of the reception vector (RXVECTOR) of the received PPDU is identical to the BSSID of the currently associated BSS or the BSSID of another BSS within the same Multiple BSSID Set or Co-Hosted BSSID Set, and the GROUP_ID is 0. In addition, with respect to a CTS frame, which is a control frame containing only an RA field, a wireless LAN terminal may determine a received PPDU as an intra-BSS PPDU when the RA field value matches the address of the previous TXOP holder, or when the RA field value matches the BSSID of the currently associated BSS or the BSSID of another BSS within the same Multiple BSSID Set/Co-Hosted BSSID Set.

In addition, a wireless LAN terminal may determine a received PPDU as an inter-BSS PPDU when the “BSS_COLOR” value of the reception vector (RXVECTOR) is not 0 and differs from the BSS_COLOR value of the currently associated BSS. In addition, with respect to a VHT PPDU, a wireless LAN terminal may determine a received PPDU as an inter-BSS PPDU when the partial AID (PARTIAL_AID) value of the reception vector (RXVECTOR) differs from the BSSID of the currently associated BSS or the BSSID of another BSS within the same Multiple BSSID Set/Co-Hosted BSSID Set. In addition, a wireless LAN terminal may determine a received PPDU as an inter-BSS PPDU when the GROUP_ID of the reception vector (RXVECTOR) is 63 and the Partial BSS Color in the most recently received HE Operation Element is 1. In addition, a wireless LAN terminal may determine a received PPDU as an inter-BSS PPDU under VHT MU/HE MU PPDU conditions when the UPLINK_FLAG value of the reception vector (RXVECTOR) is 0 and the terminal receiving the PPDU is an AP. In addition, a wireless LAN terminal may determine a received PPDU as an inter-BSS PPDU under conditions related to the BSSID when the PPDU transmits a frame that does not match the BSSID and is not a Wildcard BSSID. In addition, a wireless LAN terminal may determine a received PPDU as an inter-BSS PPDU when the PPDU does not include a BSSID field but includes both RA and TA fields and these do not match the BSSID of the same BSS, but may not be limited thereto.

Here, a basic NAV may be set in a wireless LAN terminal when the PPDU received by the wireless LAN terminal does not correspond to either an intra-BSS PPDU or an inter-BSS PPDU. In an embodiment, in the case of a CTS frame containing only an RA field, if the RA field does not match the address of the previous TXOP holder, or does not match the address of the currently associated BSS or another BSS within the same Multiple BSSID Set/Co-Hosted BSSID Set, the frame may be considered as not belonging to either intra-BSS or inter-BSS, and the basic NAV may be set in such a case.

In FIG. 9a, AP 2 (930) may be in a hidden node relationship with STA 1 (910), and since STA 1 (910) receives the CTS frame (904-1) wherein the RA field is set to AP 2 (930), the RA field does not match the address of the currently associated BSS or another BSS within the same Multiple BSSID Set/Co-Hosted BSSID Set, and therefore the basic NAV may be set. That is, since the AP to which STA 1 (910) is connected is AP 1 (920), upon receiving the CTS frame (903-1) wherein the RA field is set to AP 2 (930), the CTS frame cannot be determined to be an intra-BSS PPDU nor an inter-BSS PPDU, and therefore the basic NAV may be set.

In an embodiment, AP 3 (940) may not be able to receive the NFRP trigger frame (901) of AP 2 (930), and AP 1 (920) may be able to receive the NFRP trigger frame (901) of AP 2 (930). In the aforementioned situation, only AP 1 (920) may transmit the NDP feedback report (902-1). AP 2 (930) may not allocate a C-TDMA communication period to AP 3 (940), and instead may allocate the C-TDMA communication period to AP 1 (920), which has been determined to be capable of communication (i.e., from which an NDP feedback report was received), but may not be limited to such an embodiment.

Referring to FIG. 9B, prior to transmitting the MU-RTS frame to allocate the C-TDMA communication period, AP 2 (930) may transmit a Buffer Status Report Poll (BSRP) trigger frame (905). The BSRP trigger frame (905) may be a frame that requests the buffer status (In an embodiment, a buffer status report) of the target AP for communication. In addition, the BSRP trigger frame (905) may be a frame transmitted to verify whether an AP to which a C-TDMA communication period is to be allocated exists. The BSRP trigger frame (905) may include information indicating the OFDMA RU on which APs (In an embodiment, AP 1 (920) and AP 3 (940)) may transmit a buffer status report (BSR).

When AP 1 (920) and AP 3 (940) receive the BSRP trigger frame (905) transmitted by AP 2 (930), AP 1 (920) and AP 3 (940) may transmit buffer status reports (906-1, 906-2) as a response on the RU (i.e., frequency) indicated by the BSRP trigger frame (905). The buffer status reports (906-1, 906-2) may be frames indicating the transmission buffer status of the APs. AP 2 (930) may be aware of which AP responded based on the received buffer status reports (906-1, 906-2).

Here, in an embodiment, the AP to which AP 2 (930) intends to allocate a C-TDMA communication period may be AP 3 (940). However, this is for convenience of explanation only and may not be limited thereto. AP 2 (930) may verify whether AP 3 (940) responded to the BSRP trigger frame (905) transmitted by AP 2 (930). When AP 3 (940) has responded, AP 2 (930) may transmit the MU-RTS frame (907) that allocates the C-TDMA communication period to AP 3 (940). AP 3 (940), which is allocated the C-TDMA communication period, may transmit a CTS frame (908-2) in response to the MU-RTS frame (907) of AP 2 (930). In addition, AP 1 (920), which has not been allocated a C-TDMA communication period but is able to receive the MU-RTS frame (907), may transmit a CTS frame (908-1) in response to the MU-RTS frame (907) of AP 2 (930). Here, the CTS frames transmitted by AP 1 (920) and AP 3 (940) may be S-CTS frames. Since the CTS frame is an immediate response frame to the MU-RTS frame, it may be transmitted as a response even when the NAV is set.

In an embodiment, AP 3 (940) may communicate with a STA connected to AP 3 (940) (In an embodiment, STA 2 (950)) while ignoring the NAV set during the C-TDMA communication period, based on the allocated C-TDMA communication period (or shared TXOP). AP 3 (940) may transmit a downlink frame to STA 2 (950) or trigger uplink frame transmission. AP 3 (940) may transmit a trigger frame to STA 2 (950) to trigger uplink frame transmission by STA 2 (950). In an embodiment, the trigger frame transmitted to STA 2 (950) may have the CS required field set to 0. Accordingly, when STA 2 (950) receives the trigger frame, STA 2 (950) may transmit an uplink frame (In an embodiment, an uplink (UL) trigger-based (TB) physical layer protocol data unit (PPDU)) to AP 3 (940) regardless of whether the channel state detected by the NAV (i.e., virtual carrier sensing) or physical carrier sensing is in an idle state or a busy state. Here, since AP 3 (940) has been allocated a communication period from AP 2 (930), AP 3 (940) may transmit a trigger frame with the CS required bit set to 0 to STA 2 (950).

In an embodiment, STA 1 (910) may not be able to receive the MU-RTS frame (907) of AP 2 (930), but may be able to receive the CTS frame (908-1) of AP 1 (920). That is, as described above, AP 1 (920), which has not been allocated a C-TDMA communication period (or shared TXOP) from AP 2 (930), may transmit a CTS frame (908-1), and STA 1 (910) may receive the CTS frame (908-1) transmitted by AP 1 (920). Accordingly, STA 1 (910) may set the NAV for the time length indicated by the duration field included in the MAC header of the CTS frame (908-1) of AP 1 (920). That is, STA 1 (910) may not transmit a data frame to AP 1 (920) for the time length indicated by the duration field, thereby preventing interference with C-TDMA communication caused by frame transmission from STA 1 (910).

In an embodiment, since the CTS frame (908-1) transmitted by AP 1 (920) is transmitted to AP 2 (930), the receiver address (RA) field may be set to AP 2 (930). The RA field of the CTS frame (908-1) received by STA 1 (910) from AP 1 (920) may be AP 2 (930), and accordingly, a basic NAV may be set in STA 1 (910). That is, STA 1 (910) may set the basic NAV even though the CTS frame (908-1) is a frame transmitted by AP 1 (920) within the same BSS.

In an embodiment, the basic NAV may be set when the PPDU received by a wireless LAN terminal does not correspond to either an intra-BSS PPDU or an inter-BSS PPDU. Here, when a wireless LAN terminal receives a CTS frame, which is a control frame that includes only an RA field without a transmitter address (TA) field, the wireless LAN terminal may determine that the frame does not correspond to either an intra-BSS or inter-BSS frame if the RA field does not match the address of the previous TXOP holder, or does not match the address of the currently associated BSS or another BSS within the same Multiple BSSID Set/Co-Hosted BSSID Set.

More specifically, when a wireless LAN terminal receives a PPDU, the wireless LAN terminal may determine whether the PPDU is an intra-BSS PPDU or an inter-BSS PPDU. As a specific embodiment, a wireless LAN terminal may determine a received PPDU as an intra-BSS PPDU when the “BSS_COLOR” value of the reception vector (RXVECTOR) parameter of the received PPDU is 0 or is identical to the “BSS_COLOR” value of the currently associated BSS. In addition, with respect to a very high throughput (VHT) PPDU, a wireless LAN terminal may determine a received PPDU as an intra-BSS PPDU when the partial AID (PARTIAL_AID) value of the reception vector (RXVECTOR) of the received PPDU is identical to the BSSID of the currently associated BSS or the BSSID of another BSS within the same Multiple BSSID Set or Co-Hosted BSSID Set, and the GROUP_ID is 0. In addition, with respect to a CTS frame, which is a control frame containing only an RA field, a wireless LAN terminal may determine a received PPDU as an intra-BSS PPDU when the RA field value matches the address of the previous TXOP holder, or when the RA field value matches the BSSID of the currently associated BSS or the BSSID of another BSS within the same Multiple BSSID Set/Co-Hosted BSSID Set.

In addition, a wireless LAN terminal may determine a received PPDU as an inter-BSS PPDU when the “BSS_COLOR” value of the reception vector (RXVECTOR) is not 0 and differs from the BSS_COLOR value of the currently associated BSS. In addition, with respect to a VHT PPDU, a wireless LAN terminal may determine a received PPDU as an inter-BSS PPDU when the partial AID (PARTIAL_AID) value of the reception vector (RXVECTOR) differs from the BSSID of the currently associated BSS or the BSSID of another BSS within the same Multiple BSSID Set/Co-Hosted BSSID Set. In addition, a wireless LAN terminal may determine a received PPDU as an inter-BSS PPDU when the GROUP_ID of the reception vector (RXVECTOR) is 63 and the Partial BSS Color in the most recently received HE Operation Element is 1. In addition, a wireless LAN terminal may determine a received PPDU as an inter-BSS PPDU under VHT MU/HE MU PPDU conditions when the UPLINK_FLAG value of the reception vector (RXVECTOR) is 0 and the terminal receiving the PPDU is an AP. In addition, a wireless LAN terminal may determine a received PPDU as an inter-BSS PPDU under conditions related to the BSSID when the PPDU transmits a frame that does not match the BSSID and is not a Wildcard BSSID. In addition, a wireless LAN terminal may determine a received PPDU as an inter-BSS PPDU when the PPDU does not include a BSSID field but includes both RA and TA fields and these do not match the BSSID of the same BSS, but may not be limited thereto.

Here, a basic NAV may be set in a wireless LAN terminal when the PPDU received by the wireless LAN terminal does not correspond to either an intra-BSS PPDU or an inter-BSS PPDU. In an embodiment, in the case of a CTS frame containing only an RA field, if the RA field does not match the address of the previous TXOP holder, or does not match the address of the currently associated BSS or another BSS within the same Multiple BSSID Set/Co-Hosted BSSID Set, the frame may be considered as not belonging to either intra-BSS or inter-BSS, and the basic NAV may be set in such a case.

In FIG. 9B, AP 2 (930) may be in a hidden node relationship with STA 1 (910), and since STA 1 (910) receives the CTS frame (908-1) wherein the RA field is set to AP 2 (930), the RA field does not match the address of the currently associated BSS or another BSS within the same Multiple BSSID Set/Co-Hosted BSSID Set, and therefore the basic NAV may be set. That is, since the AP to which STA 1 (910) is connected is AP 1 (920), upon receiving the CTS frame (903-1) wherein the RA field is set to AP 2 (930), the CTS frame cannot be determined to be an intra-BSS PPDU nor an inter-BSS PPDU, and therefore the basic NAV may be set.

In an embodiment, AP 3 (940) may not be able to receive the BSRP trigger frame (905) of AP 2 (930), and AP 1 (920) may be able to receive the BSRP trigger frame (905) of AP 2 (930). In the aforementioned situation, only AP 1 (920) may transmit the buffer status report (906-1). AP 2 (930) may not allocate a C-TDMA communication period to AP 3 (940), and instead may allocate the C-TDMA communication period to AP 1 (920), which has been determined to be capable of communication (i.e., from which a buffer status report was received), but may not be limited to such an embodiment.

In FIG. 9a and FIG. 9b, the machine learning algorithm and machine learning unit operations illustrated in FIG. 1 through FIG. 4 may be used by AP 2 (930) to determine the target AP for C-TDMA communication. In an embodiment, AP 3 (940), to which AP 2 (930) allocates a C-TDMA communication period, may be the result determined by the machine learning unit of AP 2 (930). The determination of the transmission frequency (In an embodiment, tone, RU, or OFDMA RU) of the NDP feedback report or buffer status report indicated in the user information field included in the NFRP and BSRP frames transmitted by AP 2 (930) prior to allocating the C-TDMA communication period may be based on the machine learning algorithm and machine learning unit operations illustrated in FIG. 1 through FIG. 4.

In an embodiment, AP 2 (930) may use the machine learning unit to determine the maximum bandwidth to be used in C-TDMA communication. Based on the determined maximum bandwidth, the CTS frame transmitted by an AP that is allocated the C-TDMA communication period may be instructed to be transmitted using the maximum bandwidth, and the CTS frame transmitted by an AP that is not allocated the C-TDMA communication period may be determined to be transmitted using a different frequency and bandwidth from the CTS frame transmitted by the AP that is allocated the C-TDMA communication period. The machine learning algorithm and machine learning unit operations illustrated in FIG. 1 through FIG. 4 may also be used in the operation of AP 1 (920) determining whether to transmit a CTS frame in response to transmission of the MU-RTS frame of AP 2 (930). In an embodiment, AP 1 (920) may use the machine learning unit to determine, with parameters such as the received power of frames as input, whether STA 1 is able to receive frames from AP 2 (930) and AP 3 (940) and set the NAV. When it is determined that STA 1 (910) is able to set the NAV, AP 1 (920) may determine not to transmit an unnecessary CTS frame. Conversely, when it is determined that STA 1 is not able to set the NAV, AP 1 (920) may determine to transmit a CTS frame.

According to an embodiment of the present disclosure above, a method of operating a first AP in a wireless LAN system is provided. The first AP acquires a TXOP by occupying a medium. The first AP transmits a polling trigger frame to at least one other AP. At this point, the at least one other AP is capable of receiving a time allocation for performing communication within the TXOP acquired by the first AP. The first AP receives at least one response frame in response to the polling trigger frame. At this point, the first AP identifies one or more APs to receive the time allocation within the TXOP based on the at least one response frame. The first AP allocates a portion of the acquired TXOP to a second AP by transmitting a MU-RTS frame to the second AP among the one or more APs to receive the time allocation. After that the first AP receives a CTS frame from the second AP in response to the MU-RTS frame. In an embodiment, the polling trigger frame may be a BSRP trigger frame, and the BSRP trigger frame may include identification information identifying the at least one other AP. Also, each of the at least one response frame to the BSRP trigger frame may include a buffer status report transmitted on an OFDMA RU indicated by the BSRP trigger frame based on the identification information. The first AP may identify the one or more APs to receive the time allocation within the TXOP acquired by the first AP based on the buffer status report included in each of the at least one response frame. Also, the MU-RTS frame may include a user info field containing an AID of the second AP. Also, the CTS frame received from the second AP may be a S-CTS frame. Each of the at least one response frame to the polling trigger frame may be received from each of the one or more APs to receive the time allocation within the TXOP acquired by the first AP. Furthermore, the first AP may allocate a time interval within the acquired TXOP only to the one or more APs, among the at least one other AP, that transmitted the at least one response frame to the polling trigger frame. In an embodiment, the first AP may be a coordinating AP and the second AP may be a coordinated AP. In an embodiment, the first AP may allocate a time interval to other APs within the TXOP acquired by the first AP based on a pre-negotiation. In an embodiment, when a portion of the TXOP acquired by the first AP is allocated to the second AP, communication between the second AP and a STA connected to the second AP may be performed during the portion of the TXOP. According to another embodiment of the present disclosure, a first access point (AP) is provided. The first AP comprises at least one transceiver, at least one processor configured to control the at least one transceiver and a memory storing instructions that cause the first AP to perform specific operations by the at least one processor. The specific operations comprise: the first AP acquires a TXOP by occupying a medium. The first AP transmits a polling trigger frame to at least one other AP. At this point, the at least one other AP is capable of receiving a time allocation for performing communication within the TXOP acquired by the first AP. The first AP receives at least one response frame in response to the polling trigger frame. At this point, the first AP identifies one or more APs to receive the time allocation within the TXOP based on the at least one response frame. The first AP allocates a portion of the acquired TXOP to a second AP by transmitting a MU-RTS frame to the second AP among the one or more APs to receive the time allocation. After that, The first AP receives a CTS frame from the second AP in response to the MU-RTS frame.

According to another embodiment of the present disclosure, the first AP receives a polling trigger frame from a second AP. At this point, the second AP is an AP that has acquired a TXOP by occupying a medium, and the first AP is capable of receiving a time allocation for performing communication within the TXOP acquired by the second AP. The first AP transmits a response frame in response to the polling trigger frame. The first AP requests the time allocation within the TXOP acquired by the second AP based on the response frame. After that, The first AP receives an MU-RTS frame from the second AP to receive an allocation of a portion of the TXOP acquired by the second AP. The first AP transmits a CTS frame to the second AP in response to the MU-RTS frame. At this point, the polling trigger frame received by the first AP may be a BSRP trigger frame, and the BSRP trigger frame may include identification information identifying at least one other AP. Also, the MU-RTS frame received by the first AP may include a user info field containing an AID of the first AP. The CTS frame transmitted to the second AP may be a S-CTS frame. The first AP may be a coordinated AP and the second AP may be a coordinating AP. Furthermore, when a portion of the TXOP acquired by the second AP is allocated to the first AP, the first AP may perform a frame exchange with a STA connected to the first AP during the portion of the TXOP. According to another embodiment of the present disclosure, the first AP comprises at least one transceiver, at least one processor configured to control the at least one transceiver and a memory storing instructions that cause the first AP to perform specific operations by the at least one processor. The first AP receives a polling trigger frame from a second AP. At this point, the second AP is an AP that has acquired a TXOP by occupying a medium, and the first AP is capable of receiving a time allocation for performing communication within the TXOP acquired by the second AP. The first AP transmits a response frame in response to the polling trigger frame. At this point, the first AP requests the time allocation within the TXOP acquired by the second AP based on the response frame. The first AP receives an MU-RTS frame from the second AP to receive an allocation of a portion of the TXOP acquired by the second AP After that, the first AP transmits a CTS frame to the second AP in response to the MU-RTS frame.

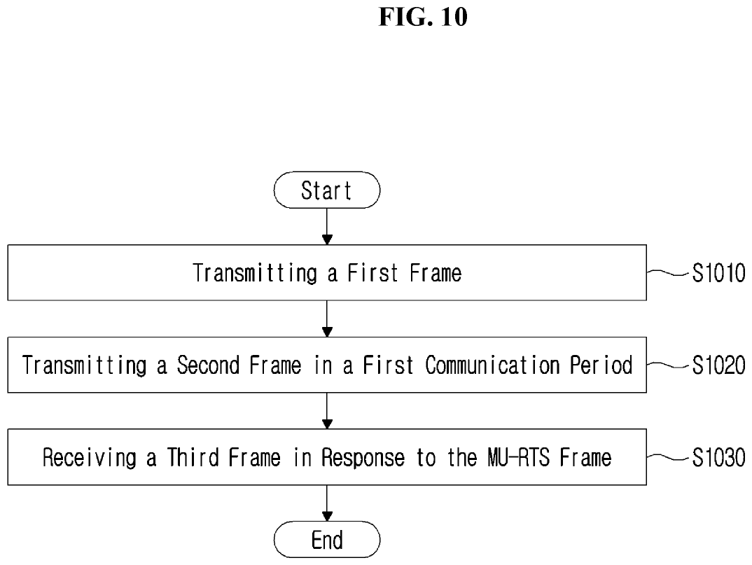

FIG. 10 is a flowchart illustrating a method of protecting a communication period when a coordinated time-division communication operation is performed in a wireless LAN to which the present disclosure is applied. A first AP may transmit a first frame (S1010). In an embodiment, the first frame may be a CTS frame, but may not be limited to such an embodiment. Here, the first AP may be an AP that coordinates time-division communication, corresponding to AP 2 described above with reference to FIG. 5 through FIG. 9B. The first frame may be a frame that sets a first network allocation vector (NAV) in at least one wireless LAN terminal receiving the first frame. That is, the first AP may transmit the first frame to at least one wireless LAN terminal, and the at least one wireless LAN terminal that receives the first frame may set the first NAV as described above and wait without performing frame transmission. Thereafter, the first AP may transmit a second frame during a first communication period established by the first frame (S1020). In an embodiment, the second frame may be an MU-RTS frame, but may not be limited thereto. The first AP may allocate, through the second frame, a second communication period to a second AP based on time-division communication within the first communication period. Here, the second AP may be AP 3 described above with reference to FIG. 5 through FIG. 9B. That is, the second AP may be an AP that receives a communication period allocation from the first AP. Thereafter, the first AP may receive a third frame from each of at least one AP including the second AP in response to the second frame (S1030). In an embodiment, the third frame may be a CTS frame, but may not be limited thereto. Here, the third frame may be a frame that sets a second NAV in at least one wireless LAN terminal receiving the third frame. In addition, the third frame may be an S-CTS frame, and the first AP may simultaneously receive the third frame from each of a plurality of wireless LAN terminals. In an embodiment, the second AP that has been allocated the second communication period may perform communication regardless of the NAV setting within the second communication period, as described above. In an embodiment, the first access point (AP) may comprise at least one transceiver, at least one processor configured to control the at least one transceiver, and a memory storing instructions that cause the wireless user device to perform specific operations by the at least one processor. Here, the specific operations may be as described above.

In addition, in an embodiment, the second frame may include user information of the second AP to which the second communication period is allocated and user information of a third AP to which the second communication period is not allocated. In an embodiment, the third AP may be AP 1 described above with reference to FIG. 5 through FIG. 9B. The second frame may further include at least one of an indicator indicating that the second AP is allocated the second communication period and an indicator indicating that the third AP is not allocated the second communication period, as described above.

In an embodiment, the second frame may include a group identifier of at least one AP capable of being allocated the second communication period based on time-division communication, and the first AP may receive the third frame from each of at least one AP including the second AP based on the group identifier. Here, when a first parameter (In an embodiment, SCRAMBLER_INITIAL_VALUE) is included together with the group identifier in the second frame, the first AP may receive the third frame from each of at least one AP including the second AP, as described above. In addition, the first NAV may be set to the time length indicated by the duration field of the MAC header included in the first frame, and the second NAV may be set to the time length indicated by the duration field of the MAC header included in the third frame.

The receiver address (RA) field in the third frame transmitted by the third AP to which the second communication period is not allocated based on the second frame may be set to the first AP. Here, the second NAV set in at least one wireless LAN terminal through the third frame transmitted by the third AP may be set as a basic NAV. That is, as described above, the RA field of the CTS frame transmitted by AP 1 in response to transmission of the second frame is set to AP 2, and STA 1 receiving the CTS frame transmitted by AP 1 may set the basic NAV.

In addition, the third frame that the first AP receives from each of at least one AP including the second AP is a simultaneous CTS (S-CTS) frame, and the first AP may simultaneously receive the third frame from each of the at least one AP including the second AP. Here, the first AP may receive the third frame, detect communication of the second AP that has been allocated the second communication period for a preset period of time, and when communication of the second AP is not detected, may reallocate the second communication period.

In an embodiment, the third frame transmitted by the second AP that has been allocated the second communication period and the third frame transmitted by the third AP that has not been allocated the second communication period may be set to different bandwidths. In an embodiment, the transmission bandwidth of the third frame transmitted by the second AP that has been allocated the second communication period may be wider than the transmission bandwidth of the third frame transmitted by the third AP that has not been allocated the second communication period.

In an embodiment, the second frame may further include frequency information on which a CTS frame is transmitted, and a band on which the CTS frame is received may be set differently for each AP based on the frequency information on which the CTS frame is transmitted. In addition, the first AP may receive the third frame from each of at least one AP including the second AP on different bands based on the frequency information on which the CTS frame is transmitted.

In an embodiment, the first AP may receive, through the entire band based on the second frame, the third frame simultaneously transmitted from each of at least one AP including the second AP, and may then receive a fourth frame from each of at least one AP including the second AP on different bands based on the frequency information on which the CTS frame is transmitted. In an embodiment, the fourth frame may be a CTS frame, but may not be limited thereto.

In addition, the first AP may transmit, after transmitting the first frame, an NFRP trigger frame to at least one AP including the second AP, and may transmit the second frame after receiving an NDP feedback frame from each of the at least one AP including the second AP. Here, the NFRP trigger frame may include identification information identifying each of at least one AP including the second AP. The NDP feedback frame transmitted from each of the at least one AP including the second AP may be received on a band corresponding to the identification information.

In an embodiment, the first AP may transmit, after transmitting the first frame, a BSRP trigger frame to at least one AP including the second AP, and may transmit the second frame after receiving a buffer status report from each of the at least one AP including the second AP. Here, the BSRP trigger frame indicates a band on which the buffer status report is transmitted, and the buffer status report transmitted from each of the at least one AP including the second AP may be received on the band indicated by the BSRP trigger frame.

The methods according to the present disclosure may be implemented in the form of program instructions executable by various computer means and recorded on a computer-readable medium. The computer-readable medium may include program instructions, data files, data structures, and the like, alone or in combination. The program instructions recorded on the computer-readable medium may be those specially designed and configured for the present disclosure, or may be those known and available to those skilled in the art of computer software.

Examples of the computer-readable medium include hardware devices specially configured to store and execute program instructions, such as ROM, RAM, and flash memory. Examples of program instructions include not only machine language code generated by a compiler, but also high-level language code executable by a computer using an interpreter or the like. The aforementioned hardware devices may be configured to operate as at least one software module to perform the operations of the present disclosure, and vice versa.

Although the present disclosure has been described with reference to the embodiments above, those skilled in the art will understand that the present disclosure may be variously modified and changed without departing from the spirit and scope of the present disclosure as set forth in the claims below.

### INDUSTRIAL APPLICABILITY

The foregoing may also be applicable to other systems.

What is claimed is:

1. A method of operating a first access point (AP) in a wireless LAN system, the method comprising:
acquiring, by the first AP, a transmit opportunity (TXOP) by occupying a medium;
transmitting, by the first AP, a polling trigger frame to at least one other AP, wherein the at least one other AP is capable of receiving a time allocation for performing communication within the TXOP acquired by the first AP;
receiving, by the first AP, at least one response frame in response to the polling trigger frame, wherein the first AP identifies one or more APs to receive the time allocation within the TXOP based on the at least one response frame;
allocating, by the first AP, a portion of the acquired TXOP to a second AP by transmitting a multi-user request to send (MU-RTS) frame to the second AP among the one or more APs to receive the time allocation; and
receiving, by the first AP, a clear to send (CTS) frame from the second AP in response to the MU-RTS frame.

2. The method of claim 1,
wherein the polling trigger frame is a buffer status report poll (BSRP) trigger frame, and the BSRP trigger frame includes identification information identifying the at least one other AP.

3. The method of claim 2,
wherein each of the at least one response frame to the BSRP trigger frame includes a buffer status report transmitted on an orthogonal frequency division multiple access resource unit (OFDMA RU) indicated by the BSRP trigger frame based on the identification information.

4. The method of claim 3,
wherein the first AP identifies the one or more APs to receive the time allocation within the TXOP acquired by the first AP based on the buffer status report included in each of the at least one response frame.

5. The method of claim 1,
wherein the MU-RTS frame includes a user info field containing an association identifier (AID) of the second AP.

6. The method of claim 1,
wherein the CTS frame received from the second AP is a simultaneous-CTS (S-CTS) frame.

7. The method of claim 1,
wherein each of the at least one response frame to the polling trigger frame is received from each of the one or more APs to receive the time allocation within the TXOP acquired by the first AP.

8. The method of claim 7,
wherein the first AP allocates a time interval within the acquired TXOP only to the one or more APs, among the at least one other AP, that transmitted the at least one response frame to the polling trigger frame.

9. The method of claim 1, wherein the first AP is a coordinating AP and the second AP is a coordinated AP.

10. The method of claim 1,
wherein the first AP allocates a time interval to other APs within the TXOP acquired by the first AP based on a pre-negotiation.

11. The method of claim 1,
wherein when a portion of the TXOP acquired by the first AP is allocated to the second AP, communication between the second AP and a station (STA) connected to the second AP is performed during the portion of the TXOP.

12. A first access point (AP) comprising:
at least one transceiver;
at least one processor configured to control the at least one transceiver; and
a memory storing instructions that cause the first AP to perform specific operations by the at least one processor,
wherein the specific operations comprise:
acquiring a transmit opportunity (TXOP) by occupying a medium;
transmitting a polling trigger frame to at least one other AP, wherein the at least one other AP is capable of receiving a time allocation for performing communication within the TXOP acquired by the first AP;
receiving at least one response frame in response to the polling trigger frame, wherein the first AP identifies one or more APs to receive the time allocation within the TXOP based on the at least one response frame;
allocating a portion of the acquired TXOP to a second AP by transmitting a multi-user request to send (MU-RTS) frame to the second AP among the one or more APs to receive the time allocation; and
receiving a clear to send (CTS) frame from the second AP in response to the MU-RTS frame.

13. A method of operating a first access point (AP) in a wireless LAN system, the method comprising:
receiving, by the first AP, a polling trigger frame from a second AP, wherein the second AP is an AP that has acquired a TXOP by occupying a medium, and the first AP is capable of receiving a time allocation for performing communication within the TXOP acquired by the second AP;
transmitting, by the first AP, a response frame in response to the polling trigger frame, wherein the first AP requests the time allocation within the TXOP acquired by the second AP based on the response frame;
receiving an MU-RTS frame from the second AP to receive an allocation of a portion of the TXOP acquired by the second AP; and
transmitting, by the first AP, a CTS frame to the second AP in response to the MU-RTS frame.

14. The method of claim 13,
wherein the polling trigger frame is a buffer status report poll (BSRP) trigger frame, and the BSRP trigger frame includes identification information identifying at least one other AP.

15. The method of claim 13,
wherein the MU-RTS frame includes a user info field containing an association identifier (AID) of the first AP.

16. The method of claim 13,
wherein the CTS frame transmitted to the second AP is a simultaneous-CTS (S-CTS) frame.

17. The method of claim 13,
wherein the first AP is a coordinated AP and the second AP is a coordinating AP.

18. The method of claim 13,
wherein when a portion of the TXOP acquired by the second AP is allocated to the first AP, the first AP performs frame exchange with a station (STA) connected to the first AP during the portion of the TXOP.

19. A first access point (AP) comprising:
at least one transceiver;
at least one processor configured to control the at least one transceiver; and
a memory storing instructions that cause the first AP to perform specific operations by the at least one processor,
wherein the specific operations comprise:
receiving, by the first AP, a polling trigger frame from a second AP, wherein the second AP is an AP that has acquired a TXOP by occupying a medium, and the first AP is capable of receiving a time allocation for performing communication within the TXOP acquired by the second AP;
transmitting, by the first AP, a response frame in response to the polling trigger frame, wherein the first AP requests the time allocation within the TXOP acquired by the second AP based on the response frame;
receiving an MU-RTS frame from the second AP to receive an allocation of a portion of the TXOP acquired by the second AP; and
transmitting, by the first AP, a CTS frame to the second AP in response to the MU-RTS frame.
